(19) United States
(12) Patent Application Publication
(10) Pub. No.: US 2026/0031626 A1
(43) Pub. Date: Jan. 29, 2026

(54) Proactive Sequential Phase Swapping Scheduling for Power Distribution Systems with a Finite Horizon

(71) Applicant: Mitsubishi Electric Research Laboratories, Inc., Cambridge, MA (US)

(72) Inventors: Hongbo Sun, Lexington, MA (US); Miroslav Kosanic, Cambridge, MA (US)

(73) Assignee: Mitsubishi Electric Research Laboratories, Inc., Cambridge, MA (US)

(21) Appl. No.: 18/784,072

(22) Filed: Jul. 25, 2024

(51) Int. Cl. H02J 3/14

(52) U.S. Cl. CPC H02J 3/144; H02J 2203/10; H02J 2203/20

(57) ABSTRACT

A phase swapping system is provided for swapping phases in a power distribution system. The system includes an interface circuitry configured to receive, from sensors arranged at buses in the power distribution system, real-time states at current time step, wherein each of the real-time states are associated with a complex power flowing from an upstream bus to a downstream bus, one or more processors and a non-transitory computer-readable storage medium having stored thereon executable instructions that, when executed by the one or more processors, cause the phase swapping system to perform steps of determining a multi-step phase swapping action by using the real-time states and a trained optimal policy generating phase swapping commands based on the multi-step phase swapping action, and transmitting, via the interface circuitry, the phase swapping commands to phase swapping devices arranged at around the sensors, wherein the phase swapping devices are configured to perform the multi-step phase swapping action based on the phase swapping commands.

### TECHNICAL FIELD

This invention relates generally to power distribution systems and more particularly to systems and methods for phase swapping of power distribution systems.

### BACKGROUND

The present invention relates generally to system and method for power distribution systems, and more particularly to phase swapping of power distribution systems.

The proliferation of single-phase inverters in residential areas, primarily due to the surge in rooftop solar photovoltaic (PV) systems and electric vehicle charging, exacerbates phase imbalances in power distribution networks. These imbalances manifest as asymmetrical loads that challenge the traditional paradigms of power distribution, potentially leading to voltage instability, increased losses, and undue stress on electrical infrastructure. More specifically, phase imbalances can result in several issues, including reduced efficiency of electrical equipment, increased energy losses, and potential overheating of conductors. Consequently, the imperative to address these imbalances through innovative grid management and planning strategies becomes increasingly critical in the pursuit of a sustainable and resilient energy future.

There are two options for balancing phases of power distribution systems. One is feeder reconfiguration at the system or substation level; the other is phase swapping at the feeder level. Since feeder reconfiguration is primarily designed for load balancing among the feeders, it cannot effectively solve phase balancing problem due to limited number of switches. Therefore, phase swapping optimization is highly desired by the electric utilities for maintaining three-phase maximally balanced by strategically assigning of each load (or each generation) to appropriate phases during a given planning horizon.

In general, the term of phase swapping is commonly used interchangeably with phase rebalancing, or phase balancing.

There are several works available that address the issue of phase swapping in power distribution systems, and most of these works are based on optimization approaches. For example, a mixed integer programming method disclosed in a paper authored by J. Zhu, M. -Y. Chow and F. Zhang, “Phase balancing using mixed-integer programming [distribution feeders],” published in IEEE Transactions on Power Systems, vol. 13, no. 4, pp. 1487-1492, Nov. 1998, doi: 10.1109/59.736295. The proposed method treated phase swapping as load assignment to lines and formulated the phase swapping problem as a mixed integer linear program over a single time step. The objective function is to minimize the weighted sum of the unbalanced branch current flows, and the Kirchoff's current laws are considered as linear constraints.

Another example can be found in the paper “Phase Rebalancing of Distribution Circuits Dominated by Single-Phase Loads,” authored by O. Pereira, J. Quirós-Tortós and G. Valverde, and published in IEEE Transactions on Power Systems, vol. 36, no. 6, pp. 5333-5344, Nov. 2021, doi: 10.1109/TPWRS.2021.3076629. In the paper, the authors formulated the phase swapping as a mixed-integer non-linear programming problem. The proposed method minimizes the number of phase connection changes of single and two-phase transformers and laterals while considering phase sequence constraints and the desired phase rebalancing. It uses geographical information system models of distribution circuits to build a reduced model and realistic load profiles offered by smart meters, or measurements at the distribution transformers to characterize the demand. This work also simplifies load flow constraints using bus power balances and is targeted at a single time step.

Yet another example is given in the paper “Robust Look-ahead Three-phase Balancing of Uncertain Distribution Loads”, published in the proceedings of the 52nd Hawaii International Conference on System Sciences, 2019, pp3542-3551, and authored by Xinbo Geng, Swati Gupta, and, Le Xie. In this paper, a robust look-ahead optimization framework is introduced to pursue balanced phases in the presence of demand-side uncertainties. A look-ahead moving window optimization method is used to reduce imbalances among phases at the cost of a limited number of phase swapping operations. This approach considers phase swapping coordination among multiple time steps, but the optimality might be impacted by the selection of the moving window.

Although the aforementioned works address phase swapping problems with different focuses, there are still limitations that need to be overcome. For example, most models do not consider voltage drop and energy loss in their mathematical formulations and ignore voltage regulation devices. Thus, these models might suffer from accuracy issues when applied to practical distribution networks. Another limitation is that the coordination of phase swapping over multiple time steps in the scheduling horizon is not explicitly considered or well-modeled. Additionally, most approaches focus solely on wye-connected generations and loads, while mixed wye and delta-connected loads and generations are rarely considered.

Therefore, there is a need for developing more advanced, more accurate, more scalable phase swapping algorithms for power distribution systems.

### SUMMARY OF THE INVENTION

One of the objectives of the present disclosure is based on the recognition that as renewable energy sources and plug-in electric vehicles increasingly penetrate power distribution networks, phase imbalances become more prevalent, posing significant challenges for electric utilities. These imbalances can compromise equipment longevity and the consistent delivery of power to consumers. This invention tackles this issue proactively by implementing phase swaps sequentially at strategic time steps and locations with determined number of swaps to improve long-term operational cost savings within a given scheduling horizon. An offline data-driven phase-swapping scheduler is developed, mimicking multi-step phase-swapping optimization through an imitation learning framework via supervised learning using random forest regression, or deep neural network. This scheduler determines the time steps and associated loads and generations requiring phase swapping. The phase swapping over the finite scheduling horizon is modeled as a multi-step mixed-integer nonlinear programming problem, utilizing a generic branch-based radial load flow model that considers both wye and delta connections for loads and generations. For an upcoming scheduling horizon, the scheduler, based on forecasted generation, load, and per unit profiles, first identifies the time steps and loads/generations requiring phase swapping. Subsequently, phase swapping actions for each time step are sequentially resolved using a mixed-integer nonlinear optimization model within determined total number of phase swaps and at determined locations. Consecutive time steps requiring phase swapping are consolidated into a multi-step mixed-integer nonlinear optimization model.

The present disclosure determines an optimal phase swapping scheme by minimizing a weighted sum of multiple objectives, including phase swap costs, power purchase and shedding expenses, penalties for operational limit violations, and penalties for phase imbalances. This is achieved while ensuring stable system operation throughout the scheduling horizon. A generic branch model is proposed to represent common distribution branches, encompassing line segments, voltage regulators, and transformers. Two different forms of branch flow based radial load flow models are derived, considering both wye- and delta-connected generations and loads. One model is based on squared voltages and squared currents, while the other is directly based on bus voltages and branch currents. Both load flow models facilitate coordinated phase swapping with voltage regulation and accurately model phase-wise voltage drops and power losses. The disclosed method achieves a good balance between model accuracy and computational efficiency.

A phase swapping system is provided for swapping phases in a power distribution system. It comprises an interface circuitry configured to receive from sensors arranged at buses in the power distribution system, real-time states at current time step of a scheduling horizon, wherein each of the real-time states are associated with a complex power flowing from an upstream bus to a downstream bus, and one or more processors and a non-transitory computer-readable storage medium having stored thereon executable instructions that, when executed by the one or more processors, cause the phase swapping system to perform steps of determining a multi-step phase swapping action by using the real-time states and a trained optimal policy; generating phase swapping commands based on the multi-step phase swapping action; and transmitting, via the interface circuitry, the phase swapping commands to phase swapping devices arranged at around the sensors, wherein the phase swapping devices are configured to perform the multi-step phase swapping action based on the phase swapping commands.

In the propsed system, phase swapping action is represented by using a matrix for assigning each wye-connected location to a phase for each wye-connected load and generation, and a matrix for assigning each delta-connected location to a phase-pair for each delta-connected generation and load. Meanwhile, phase swapping command for a wye-connected generation or load is described by a series of connected phases at previous and current time steps; wherein phase swapping command for a delta-connected generation or load is described by a series of phase-pairs at previous and current time steps;

In the proposed system, the optimal policy is pretrained offline for the scheduling horizon by using a state-action training set. The state-action training set is generated for determining the multi-step phase swapping action for a training scenario using a multi-step mixed-integer non-linear programming (MINLP). The training scenario is represented by using generation, load profiles for all buses and per-unit cost profiles with respect to the power distribution system. The trained optimal policy is used to determine a guided set for phase swapping action corresponding to the generation, load and per-unit cost profiles for the scheduling horizon. The guided set for phase swapping action defining time steps, total number of switching, and corresponding locations required for phase swapping. The multi-step phase swapping action is generated by sequentially determining phase swapping action for each single time step that required phase swapping determined by the optimal policy; wherein single-step phase swapping action is obtained by solving a single-step phase swapping optimization model that formulated by minimizing weighted sum of multiple operational cost functions subject to radial load flow constraints, substation voltage settings, phase swapping feasibility and a guided set of phase swapping action for the time step. The multi-step phase swapping optimization model is used for generating single-step phase swapping action for each of multiple consecutive time steps that required phase swapping determined by the optimal policy.

The proposed system approximated the trained optimal policy through a deep neural network or random forest model, in which total number of phase swapping for each time step, and statuses for phase swapping for each wye-connected and delta-connected loads and generations are taken as outputs, and at least total net active and reactive power injections for all fixed-connection buses for each wye-connected phase and each delta-connected phase pair, active and reactive power injections for each swappable-connection bus for each wye-connected location and each delta-connected location, and per unit purchase costs for active and reactive powers for each time step are taken as inputs.

Further, some embodiments of the present disclosure provide a non-transitory computer-readable medium storing a phase swapping program. The phase swapping program includes instructions that, when executed by a processor, causes a phase swapping system connected to a power distribution system through an interface circuitry, to: receive, from sensors arranged at buses in the power distribution system, real-time states at current time step of a scheduling horizon, wherein each of the real-time states are associated with a complex power flowing from an upstream bus to a downstream bus; determine a multi-step phase swapping action by using the real-time states and a trained optimal policy; phase swapping commands based on the multi-step phase swapping action; and transmit, via the interface circuitry, the phase swapping commands to phase swapping devices arranged at around the sensors, wherein the phase swapping devices are configured to perform the multi-step phase swapping action based on the phase swapping commands.

### BRIEF DESCRIPTION OF DRAWINGS

The present disclosure is further described in the detailed description which follows, in reference to the noted plurality of drawings by way of non-limiting examples of exemplary embodiments of the present disclosure, in which like reference numerals represent similar parts throughout the several views of the drawings. The drawings shown are not necessarily to scale, with emphasis instead generally being placed upon illustrating the principles of the presently disclosed embodiments.

FIG. 1 shows a schematic of a method for proactive sequential phase swapping in power distribution systems over a finite scheduling horizon.

FIG. 2A depicts an IEEE 13-node test feeder represented as a one-line diagram.

FIG. 2B illustrates an unbalanced three-phase power distribution system represented by a full-phase diagram.

FIG. 2C depicts a modified IEEE 13 node test feeder with phase swapping devices (i.e. phase swapper) represented by a full-phase diagram.

FIG. 3 is a schematic for modeling a generic branch (i,j)∈ [symbol] using the regulated π model.

FIG. 4 shows a set of normalized profiles for load demands, solar generation, wind generation, and power purchase prices.

FIG. 5A lists the comparison of summarized phase swapping schedules determined using different phase swapping strategies.

FIG. 5B lists the detailed phase connection changes in the phase swapping schedule, determined using a sequential single-step phase swapping optimization strategy.

FIG. 5C lists the detailed phase connection changes in the phase swapping schedule, determined using either a simultaneous multi-step phase swapping optimization strategy or a proactive sequential single-step phase swapping optimization strategy.

FIG. 6A depicts total operational cost variations over time within the finite scheduling horizon using no phase swapping strategy.

FIG. 6B depicts total operational cost variations over time within the finite scheduling horizon using the sequential single-step phase swapping strategy.

FIG. 6C depicts total operational cost variations over time within the finite scheduling horizon using the simultaneous multi-step phase swapping strategy.

FIG. 7A depicts substation by-phase active power variations over time within the finite scheduling horizon using no phase swapping strategy.

FIG. 7B depicts substation by-phase active power variations over time within the finite scheduling horizon using the sequential single-step phase swapping strategy.

FIG. 7C depicts substation by-phase active power variations over time within the finite scheduling horizon using the simultaneous multi-step phase swapping strategy.

FIG. 8A depicts substation by-phase reactive power variations over time within the finite scheduling horizon using no phase swapping strategy.

FIG. 8B depicts substation by-phase reactive power variations over time within the finite scheduling horizon using the sequential single-step phase swapping strategy.

FIG. 8C depicts substation by-phase reactive power variations over time within the finite scheduling horizon using the simultaneous multi-step phase swapping strategy.

FIG. 9 shows a schematic of a system for proactive sequential phase swapping in power distribution systems over a finite scheduling horizon.

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in the art which fall within the scope and spirit of the principles of the presently disclosed embodiments.

### DETAILED DESCRIPTION

In the following description, for purposes of explanation, numerous specific details are set forth to provide a thorough understanding of the present disclosure. It will be apparent, however, to one skilled in the art that the present disclosure may be practiced without these specific details. In other instances, apparatuses and methods are shown in block diagram form only to avoid obscuring the present disclosure.

As used in this specification and claims, the terms “for example,” “for instance,” and “such as,” and the verbs “comprising,” “having,” “including,” and their other verb forms, when used in conjunction with a listing of one or more components or other items, are each to be construed as open ended, meaning that the listing is not to be considered as excluding other, additional components or items. The term “based on” means at least partially based on. Further, it is to be understood that the phraseology and terminology employed herein are for the purpose of the description and should not be regarded as limiting. Any heading utilized within this description is for convenience only and has no legal or limiting effect.

The goal of phase swapping scheduling over a given time horizon is to determine phase swapping schemes for each time step within the time horizon to minimize associated operational costs while maintaining system stable and secure operation. This is a multi-step optimization problem. Generally, two different solution strategies can be applied.

The first strategy involves solving the phase swapping problem sequentially, step by step, where each time step is addressed separately to adjust phase connections for swappable loads and generations according to the previous step values. This approach can quickly obtain solutions, but they are usually locally optimal.

The second strategy involves solving the multi-step problem as a whole, with all time steps addressed simultaneously. This approach can achieve globally optimal solutions for the entire time horizon but suffers from a heavy computational burden, particularly for large-scale systems.

To address this, a novel proactive approach is disclosed in this invention. It uses imitative learning (i.e. imitation learning) of multi-period phase swapping optimization to identify the time steps with phase swapping needs and the relevant loads and generations for phase swapping based on predicted load, generation and per-unit cost profiles. Then, an optimal phase swapping scheme is solved only for the necessary time steps with determined sets of loads and generations for phase swapping. By doing so, phase swapping scheduling with better optimality can be determined with reasonably limited computational efforts.

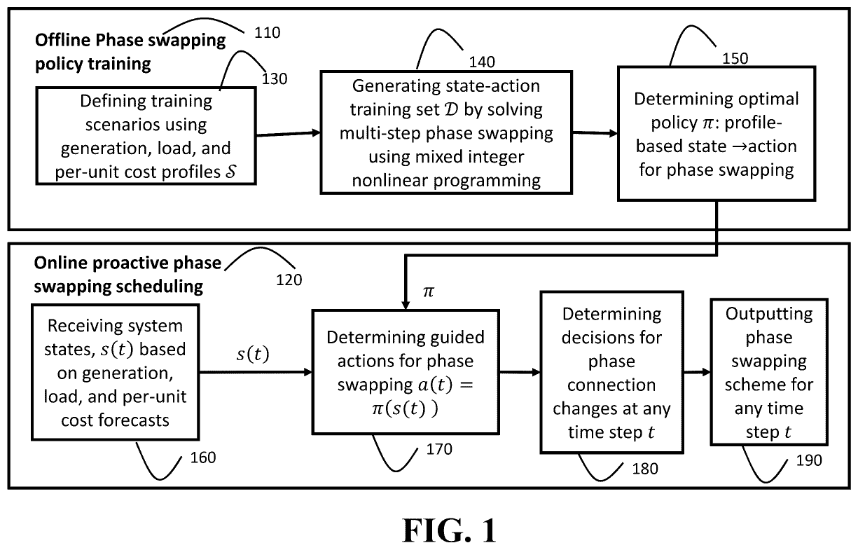

FIG. 1 is a schematic for the method of proactive sequential phase swapping of power distribution systems over a finite scheduling horizon.

As shown in FIG. 1, the phase swapping scheduling for a finite planning horizon T includes two stages, the first stage 110 is offline training stage to model the relationship between phase swapping actions, and load, generation and per unit profile states based on imitation learning, and the second stage 120 is online scheduling stage to generate full decisions on phase connection changes and related generation schedule according to real-time load, generation and per unit cost forecasts. The imitation learning mimics a mixed-integer non-linear programming (MINLP) solver of the multi-step phase swapping optimization problem, and the policy demonstrated by the MINLP expert is approximated with a deep neural network or an ensemble random forest model.

The off-line training stage 110 includes step 130 for defining training scenarios using load, generation and per-unit cost profiles S, step 140 for generating state-action training set D by solving multi-step phase swapping using MINLP, and step 150 for determining optimal phase swapping policy π: state→action, that is deciding is phase swapping to be taken and where phase swapping to be taken based on corresponding load, generation and per-unit cost profiles. In this invention, the state for each time step includes the total un-swappable active and reactive power injections for each wye-connected phase and delta-connected phase pair within the system, the active and reactive power injections at each wye-connected location, or delta-connected location for each swappable load/generation, and the action at each time step defines if a phase swapping is needed at the specific time step, how many total phase swaps required, and which swappable load or generation needs phase swapping.

The online phase swapping scheduling stage 120 includes step 160 for receiving system state s(t), using load, generation and per-unit cost forecasts, step 170 for determining guided action for phase swapping α(t)=π(s(t)) for each time t, step 180 for determining detailed phase connection changes for each swappable load/generation and substation power purchase decisions at time t, and step 190 for outputting phase swapping scheme for time t. Guided action for phase swapping provides guidance on whether phase swapping is needed at time t, how many swaps are required, and which loads and generations require swapping.

In this section, we will first propose a generic branch model using the regulated π model to represent commonly used branches in power distribution systems, including line segments, voltage regulators, and transformers. Next, we will derive branch-flow-based load flow models for radial distribution systems, either in terms of squared voltages and currents or explicitly using bus voltages and branch currents. Following this, we will present two mixed-integer nonlinear programming models using different load flow formulations to generate training samples for mimicking optimal phase swapping schemes over the finite planning horizon. Finally, we will describe the proactive phase swapping approach, which applies imitation learning to tackle the multi-step phase swapping problem, achieving a good compromise between solution optimality and computational burden.

### Unbalanced Three-Phase Power Distribution System

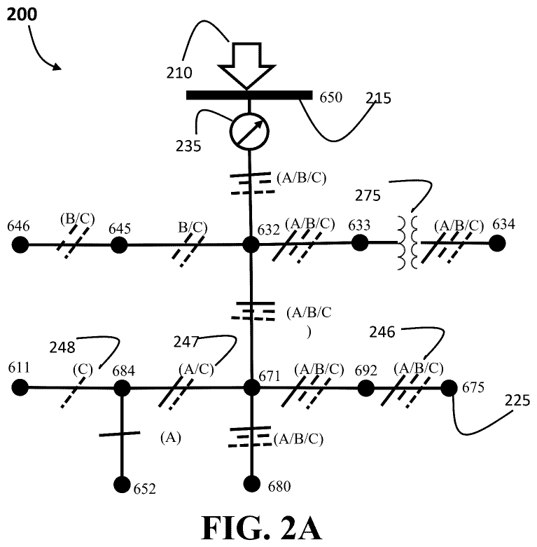

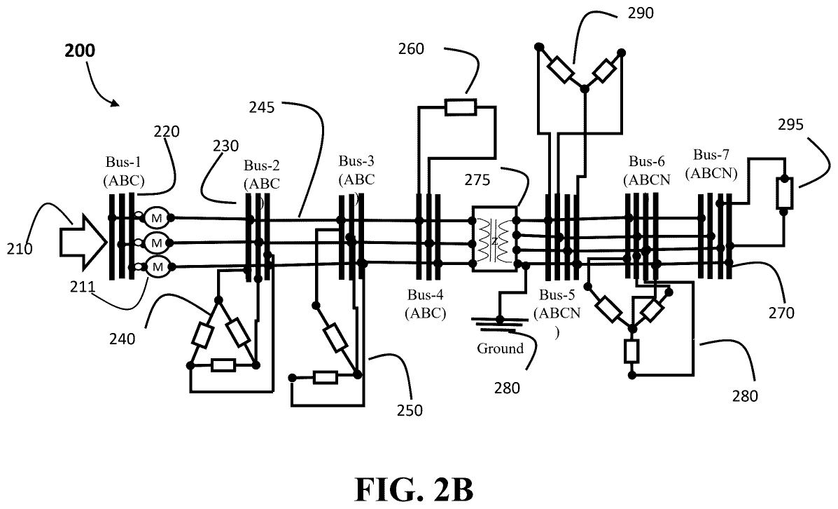

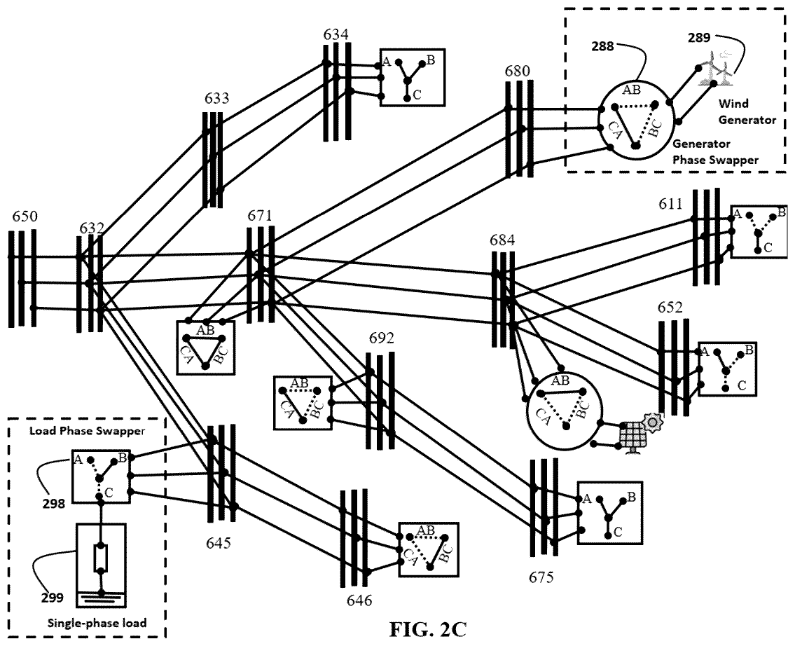

FIG. 2A shows an exemplary three-phase power distribution system 200, i.e., the IEEE 13-node test feeder, represented using a one-line diagram. As illustrated, the typical power distribution system 200 adopts a radial configuration. Power originates from the main grid (or transmission system) 210, travels through a substation bus (or feeder head) 215, and is delivered to customer loads connected to buses 225 through line segments. The system may incorporate voltage regulation devices like the voltage regulator 235 and transformer 275. It is inherently unbalanced and may consist of three-phase components (e.g., line 246), two-phase components (e.g., line 247), or single-phase components (e.g., line 248).

FIG. 2B illustrates an unbalanced three-phase power distribution system 200 represented using a full-phase diagram. The power fed from the main grid 210 is measured by sensors 211 at the feeder head 220. Based on grounding conditions, this system can be divided into two portions. The left portion, bounded by the feeder head 220 and the left side of transformer 275, is an ungrounded three-phase three-wire system. In this section, buses 230 are not grounded, and each line segment contains only phase wires. The right portion, starting from the right side of transformer 275 and extending downstream, is a grounded three-phase four-wire system. Here, each line contains a neutral wire in addition to phase wires, and each bus 270 is connected with both phase and neutral wires. Transformer 275 is grounded by connecting one of its terminals to the earth 280. Multiple groundings are commonly adopted for operational and safety needs in power distribution systems. The system includes both delta-connected loads 240, 250, and 260, and wye-connected loads 280, 290, and 295. Wye-connected loads are connected between a phase and the neutral for each phase load component, while delta-connected loads are connected between two phases of the three phases for each phase-pair load component.

FIG. 2C depicts a modified IEEE 13-node test feeder with phase swapping devices, represented by a full-phase diagram, ignoring neutral connections. This system is modified from the feeder depicted in FIG. 2A by replacing all transformers, voltage regulators, and single or double-phase line segments with three-phase line segments, and adding a solar generator at bus 684 and a wind generator at bus 680. Some loads and generations are phase swappable, while others are not.

For a phase-swappable load 299, its phase swapping is implemented through an automatic load phase swapping device, phase swapper 298. The load 299 is a single-phase wye-connected load, and its phase can switch among phase A, phase B, and phase C. It currently resides at phase B (solid line represents the initial position, and the dashed line represents candidate positions). Similarly, for a phase-swappable generation 289, its phase can be switched through a generator phase swapping device, phase swapper 288. In this example, the generator 289 is a single-phase delta-connected wind generator. It can be relocated among phase pairs CA, AB, or BC, with its initial position on phase pair CA.

For a three-phase radial distribution network, we use [symbol] ={0,1, . . . , n} denoting the set of buses, in which 0 is the index the substation (or point of common coupling to transmission system), and [symbol] ⁺⁼ [symbol] ^{\{}0}. We also use [symbol] denoting the set of branches connecting between a pair of buses. (i,j) represents a branch connecting an ordered pair of buses (i,j), where bus i lies between bus 0 and bus j. We use (i, j)∈ [symbol] and i→j interchangeably.

For ease of exposition and notation simplicity, we assume that all the buses i∈ [symbol] and branches (i,j)∈ [symbol] have three phases: a, b, c; and define Φ_{γ}: ={a, b, c} and Φ_{D}: ={ab, bc, ca}. For i∈ [symbol] and Φ∈Φ_{γ},

$$let {V}_{i}^{ϕ}$$

denote the complex voltage on phase ϕ of bus i, and define

$${V}_{i} := {[ \begin{matrix}{V}_{i}^{a} & {V}_{i}^{b} & {V}_{i}^{c}\end{matrix} ]}^{T} .$$

For i→j and ϕ∈Φ_{γ}, let

$${I}_{ij}^{ϕ} and {S}_{ij}^{ϕ}$$

denote the current and power flow on the phase ϕ of branch from bus i to bus j, and define

$${I}_{ij} := {[ \begin{matrix}{I}_{ij}^{a} & {I}_{ij}^{b} & {I}_{ij}^{c}\end{matrix} ]}^{T} , and {S}_{ij} := [ \begin{matrix}{S}_{ij}^{a} & {S}_{ij}^{b} & {{S}_{ij}^{c} ]}^{T} .\end{matrix}$$

If any phase ϕ is missing, the corresponding voltage, current, or power flow components will be set as zero. Loads and generations at any bus can also be differentiated by their locations, and we can define [symbol] _{γ}: ={a, b, c} and [symbol] _{D}: ={ab, bc, ca} to represent the location sets for wye-connected and delta-connected loads or generations at a bus with full phases.

Without loss of generality, let every bus i∈ [symbol] have three wye-connected generations and loads (one on each phase, with grounded neutral at three wye-connected locations) and three delta-connected generations and loads (one across each pair of phases, ungrounded at three delta-connected locations). Let

$${s}_{G , {Y}_{i}} := {[ \begin{matrix}{s}_{G , {Y}_{i}}^{a} & {s}_{G , {Y}_{i}}^{b} & {s}_{G , {Y}_{i}}^{c}\end{matrix} ]}^{T} and {s}_{L , {Y}_{i}} := {[ \begin{matrix}{s}_{L , {Y}_{i}}^{a} & {s}_{L , {Y}_{i}}^{b} & {s}_{L , {Y}_{i}}^{c}\end{matrix} ]}^{T}$$

denote the complex power productions and consumptions of wye-connected generations and loads at bus i. Let

$${s}_{G , {D}_{i}} := {[ \begin{matrix}{s}_{G , {D}_{i}}^{ab} & {s}_{G , {D}_{i}}^{bc} & {s}_{G , {D}_{i}}^{ca}\end{matrix} ]}^{T} and {s}_{L , {D}_{i}} := {[ \begin{matrix}{s}_{L , {D}_{i}}^{ab} & {s}_{L , {D}_{i}}^{bc} & {s}_{L , {D}_{i}}^{ca}\end{matrix} ]}^{T}$$

denote the power productions and consumptions of delta-connected generations and loads at bus i, respectively. If a particular phase of a particular type of connection does not exist at bus i, then the corresponding element of S_{G,Y}_{ᵢ}, S_{L,Y}_{ᵢ} or S_{G,D}_{ᵢ}, S_{L,D}_{ᵢ} are set as 0. In practice, S_{G,Y}_{ᵢ}, S_{L,Y}_{ᵢ} or S_{G,D}_{ᵢ}, S_{L,D}_{ᵢ} represent the power productions and consumptions observed on the primary windings of the wye and delta-connected service transformers at bus i. Their secondary windings, which connect to loads and distributed energy resources, are ignored from our model. The delta-connected complex power injections at bus i, (S_{G,D}_{ᵢ}−S_{L,D}_{ᵢ}) will be converted into wye-connected ones, A_{S}_{_{D→Y}}(S_{G,D}_{ᵢ}−S_{L,D}_{ᵢ}) by using a delta-to-wye conversion matrix A_{S}_{_{D→Y}}∈ [symbol] ^{3×3}. The delta-to-wye conversion matrix is determined by assuming voltages are balanced at bus i, that is:

$$\frac{{V}_{i}^{a}}{{V}_{i}^{b}} \approx \frac{{V}_{i}^{b}}{{V}_{i}^{c}} \approx \frac{{V}_{i}^{c}}{{V}_{i}^{a}} \approx {e}^{j 2 π / 3} ,$$

and set as:

$${A}_{{S}_{D \to Y}} = [ \begin{matrix}\frac{1}{2} - j \frac{\sqrt{3}}{6} & 0 & \frac{1}{2} + j \frac{\sqrt{3}}{6} \\ \frac{1}{2} + j \frac{\sqrt{3}}{6} & \frac{1}{2} - j \frac{\sqrt{3}}{6} & 0 \\ 0 & \frac{1}{2} + j \frac{\sqrt{3}}{6} & \frac{1}{2} - j \frac{\sqrt{3}}{6}\end{matrix} ] .$$

Any delta-connected generation and load is converted to equivalent wye-connected generation and load through this delta-to-wye coversion matrix defined by assuming balanced three phases.

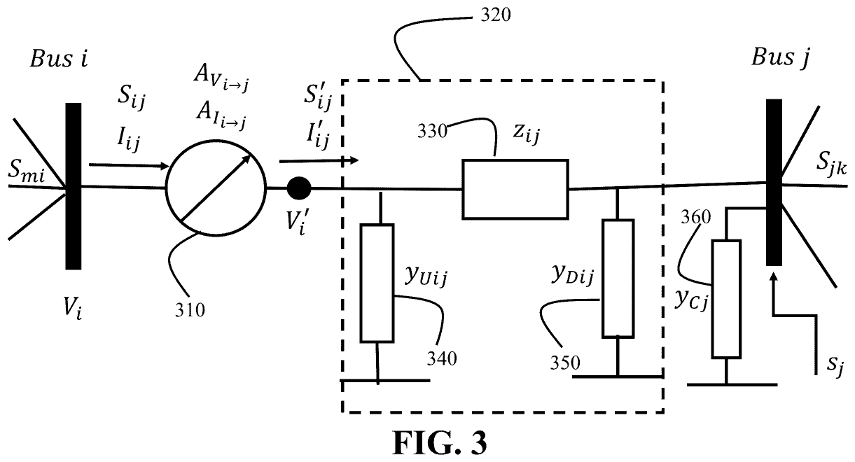

There are three typical branches in the power distribution system, including a line segment, a voltage regulator, and a transformer that can be modeled through a generic branch model, as shown in FIG. 3.

FIG. 3 is a schematic for a generic branch (i,j)∈ [symbol] modeled using a regulated π model. It can be expressed as a regulator 310, modeled using voltage and current conversion matrices, connected with a series branch 320 modeled using series impedance 330 and shunt admittances 340 and 350. The regulator is connected between bus i and an intermediate bus i′, and the series branch is connected between the intermediate bus i′ and bus j. In the figure, y_{Cj}∈ [symbol] ^{3×3} 360 denotes the shunt admittance, such as capacitor banks at bus j, γ_{Uij}, γ_{Dij}∈ [symbol] ^{3×3} denote the equivalent shunt admittance of branch (i, j) introduced by line segments, voltage regulators, or transformer branch (i,j), and zᵢⱼ∈ [symbol] ^{3×3} denotes the series impedance of branch (i,j). A_{Vi}_{_{→j}}∈ [symbol] ^{3×3} and Aₗ_{_{i→j}}∈ [symbol] ^{3×3} denote the voltage and current conversion factor matrices between the primary and secondary sides of the voltage regulator or transformer between bus i and bus j. [symbol] , [symbol] and N denote the set of real, complex, and nonzero natural numbers, respectively. A_{V}_{_{i→j}} and Aₗ_{_{i→j}} can be regarded as a voltage amplifying matrix and a current amplifying matrix.

According to the type of branches, we can be configured associated parameter matrices for the branch accordingly. For a line segment (i,j)∈ [symbol] , A_{V}_{_{i→j}} and Aₗ_{_{i→j}} are identity matrices, zᵢⱼ, y_{Uij} and y_{Dij} are the series impedance between bus i and bus j and shunt admittances evenly allocated to bus i and bus j, respectively.

For a voltage regulator branch (i,j)∈ [symbol] , A_{V}_{_{i→j}} and Aₗ_{_{i→j}} are determined based on the voltage regulator primary and secondary winding connections, and tap ratios, and used to convert voltages and currents at primary side (bus i) to ones at the secondary side (bus i′). zᵢⱼ is the series impedance of regulated line segment (i′,j), and y_{Uij} and y_{Dij} are the half-shunt admittances for the regulated line segment, y_{cj} is shunt admittance at bus j.

For a transformer branch (i, j)∈ [symbol] , A_{V}_{_{i→j}} and Aₗ_{_{i→j}} are determined based on the transformer primary and secondary winding connections, and tap ratios. zᵢⱼ and y_{Uij} and y_{Dij} represent the equivalent series impedance and shunt admittances of the transformer determined according to its impedance and admittance, winding connections and tap ratios.

Radial Load Flow Formulations with Generic Branch Model

For notational simplicity, we assume that all the buses and lines have three phases. To deal with missing phases on certain buses and lines, we fill zeros at the corresponding locations of current/power/voltage vectors and impedance/admittance matrices.

The following notations are used to formulate the load flow model. Define j=\sqrt{−1}. For a complex number c, Re (c) and Im(c) denote its real and imaginary parts, respectively. For n∈ [symbol] , let [symbol] ^{n×n} denote the space of all n-by-n Hermitian matrices. For any scalar, vector, or matrix A, let A^{T}, A*,and A^{H} denote its transpose, element-wise conjugate, and conjugate transpose, respectively. Further, given an n-by n matrix A, diag(A) denotes the column vector composed of its diagonal entries.

Considered most of power distribution systems installing with voltage regulation devices, such as voltage regulars and transformers, it is important for modeling this kind of devices in load flows to maintain load flow solution with sufficient accuracy, in particular, for phase imbalance problems. Unfortunately, most of conventional branch flow based load flow models ignore such kind of devices in load flow calculations. To this end, this invention extends conventional branch flow based load flow models with capability for modelling voltage regulation devices using the generic branch model as represented by FIG. 3.

For a branch (i,j)∈ [symbol] modeled using regulated π model as shown in FIG. 3, bus i and bus j are the sending and receiving buses of (i,j)∈ [symbol] , and bus j and bus k are the sending and receiving buses of (j, k)∈ [symbol] . Through the regulators, the currents injected into the branch from bus i, Iᵢⱼ and voltages at bus i, Vᵢ can be regulated into related ones at intermediate bus i′,

$${I}_{ij}^{′} and {V}_{i}^{′} , where {I}_{ij}^{′} = {A}_{{I}_{i \to j}} {I}_{ij} , {V}_{i}^{′} = {A}_{{V}_{i \to j}} {V}_{i} .$$

### Load Flow Formulation-I: Using Squared Voltages and Currents

For branch (i, j)∈ [symbol] , three sets of variables are used to represent network states, including expanded branch flows,

$${\tilde{S}}_{ij} = {V}_{i} {I}_{ij}^{H} ∈ {ℂ}^{3 \times 3}$$

representing power flowing from bus i toward bus j, squared currents,

$${\tilde{I}}_{ij} = {I}_{ij} {I}_{ij}^{H} ∈ {ℍ}^{3 \times 3}$$

representing squared current passing through branch from bus i toward bus j, and squared voltages,

$${\tilde{V}}_{i} = {V}_{i} {V}_{i}^{H} ∈ {ℍ}^{3 \times 3}$$

representing squared voltages at bus i. The actual power flowing from i toward bus j can be calculated as Sᵢⱼ=diag(\tilde{S}ᵢⱼ).

Using expanded power flows and squared voltages and currents, the power flow on branch (i, j) can be formulated as follows:

$$( 1 )$$

$${\sum }_{i : i \to j} diag ( {A}_{{V}_{i \to j}} {\tilde{S}}_{ij} {A}_{{I}_{i \to j}}^{H} - {A}_{{V}_{i \to j}} {\tilde{V}}_{i} {A}_{{V}_{i \to j}}^{H} {y}_{Uij}^{H} - {\tilde{V}}_{j} {y}_{Dij}^{H} + {z}_{ij} {y}_{Uij} {A}_{{V}_{i \to j}} {\tilde{S}}_{ij} {A}_{{I}_{i \to j}}^{H} - \text{} {z}_{ij} {y}_{Uij} {A}_{{V}_{i \to j}} {\tilde{V}}_{i} {A}_{{V}_{i \to j}}^{H} {y}_{Uij}^{H} + {z}_{ij} {A}_{{I}_{i \to j}} {\tilde{S}}_{ij}^{H} {A}_{{V}_{i \to j}}^{H} {y}_{Uij}^{H} - {z}_{ij} {A}_{{I}_{i \to j}} {\tilde{I}}_{ij}^{H} {A}_{{I}_{i \to j}}^{H} ) - diag ( {\tilde{V}}_{j} {y}_{Cj}^{H} ) + {s}_{j} = {\sum }_{k : j \to k} diag ( {S}_{jk} )$$

$${s}_{j} = {s}_{G , {Y}_{j}} - {s}_{L , {Y}_{j}} + {A}_{{S}_{D \to Y}} {s}_{G , {D}_{j}} - {A}_{{S}_{D \to Y}} {s}_{L , {D}_{j}} \qquad ( 2 )$$

$$( 3 )$$

$${A}_{{V}_{i \to j}} {\tilde{V}}_{i} {A}_{{V}_{i \to j}}^{H} - {\tilde{V}}_{j} = {A}_{{V}_{i \to j}} {\tilde{S}}_{ij} {A}_{{I}_{i \to j}}^{H} {z}_{ij}^{H} - {A}_{{V}_{i \to j}} {\tilde{V}}_{i} {A}_{{V}_{i \to j}}^{H} {y}_{Uij}^{H} {z}_{ij}^{H} + {z}_{ij} {A}_{{I}_{i \to j}} {\tilde{S}}_{ij}^{H} {A}_{{V}_{i \to j}}^{H} - {z}_{ij} {A}_{{I}_{i \to j}} {\tilde{I}}_{ij} {A}_{{I}_{i \to j}}^{H} {z}_{ij}^{H} + {z}_{ij} {A}_{{I}_{i \to j}} {\tilde{S}}_{ij}^{H} {A}_{{V}_{i \to j}}^{H} {y}_{Uij}^{H} {z}_{ij}^{H} - {z}_{ij} {y}_{Uij} {A}_{{V}_{i \to j}} {\tilde{V}}_{i} {A}_{{V}_{i \to j}}^{H} + {z}_{ij} {y}_{Uij} {A}_{{V}_{i \to j}} {\tilde{S}}_{ij} {A}_{{I}_{i \to j}}^{H} {z}_{ij}^{H} - {z}_{ij} {y}_{Uij} {A}_{{V}_{i \to j}} {\tilde{V}}_{i} {A}_{{V}_{i \to j}}^{H} {y}_{Uij}^{H} {z}_{ij}^{H}$$

$$[ \begin{matrix}{\tilde{V}}_{i} & {\tilde{S}}_{ij} \\ {\tilde{S}}_{ij}^{H} & {\tilde{I}}_{ij}\end{matrix} ] = 0 \qquad ( 4 )$$

Equation (1) enforces the complex power balance at bus j. The left-hand side (LHS) of (1) consists of the complex power leaving bus i towards bus j subtracted complex power flowing along shunt elements at bus i and bus j, power losses on the branch from bus i to bus j, and added complex power injected at bus j, while the right-hand side (RHS) of (1) represents the complex power sent to downstream buses.

Equation (2) enforces the complex power injected at bus j, S₁ consists of wye-connected complex power generations and loads S_{G,Y}_{ⱼ}, s_{L,Y}_{ⱼ}, and complex power generations and loads converted from delta-connected generations and loads, S_{G,D}_{ⱼ}, s_{L,D}_{ⱼ}.

Equation (3) describes the squared voltage drop along the branch from bus i to bus j. It accounts for the voltage at bus i, the voltage drops due to the power flow and the branch series impedance.

Equation (4) calculates the magnitude of the square current in the branch based on the expanded power flow and the square voltage at the sending end of the branch.

The equations (1)-(4) can be separated into the real and reactive components to be solved.

When taking the above-described as operational constraints in phase swapping optimization problems. (1)˜(3) are convex linear constraints. The equation (4) is a nonconvex because of the quadratic equations. The semidefinite relation is used to obtain a convex surrogate of (4). (4) is relaxed with a positive semidefinite constraint (5) for a branch (i, j)∈ [symbol] :

$$[ \begin{matrix}{\tilde{V}}_{i} & {\tilde{S}}_{ij} \\ {\tilde{S}}_{ij}^{H} & {\tilde{I}}_{ij}\end{matrix} ] ≽ 0 \qquad ( 5 )$$

### Load Flow Formulation-II: Using Explicit Bus Voltages and Branch Currents

For a large-scale power distribution system, the branch flow-based model expressed in terms of squared voltages and currents has a considerably larger number of decision variables, which leads to a computational burden when modeled as constraints for phase swapping optimization. To overcome this challenge, a branch flow-based load flow model in terms of explicit bus voltages and branch currents is proposed here. For any branch i→j, three equations are used to describe its power flow allocation. The first equation is a voltage drop equation:

$${A}_{{V}_{i \to j}} {V}_{i} - {V}_{j} = {z}_{ij} ( {A}_{{I}_{i \to j}} {I}_{ij} - {y}_{Uij} {A}_{{V}_{i \to j}} {V}_{i} ) \qquad ( 6 )$$

where Vᵢ and Vⱼ are the complex voltages at sending bus and receiving bus of branch i→j, A_{V}_{_{i→j}} is the ideal voltage conversion factor matrices to amplify voltage at sending bus, and A_{I}_{ⱼᵢ} j is the ideal current conversion factor matrix to amplify current injected from sending bus into the branch i→j. zᵢⱼ, and y_{Uij} are an equivalent series impedance matrix for branch i→j, and equivalent shunt admittance matrix at bus i.

The second equation is a current balance equation for any bus j:

$${\sum }_{i : i \to j} ( {A}_{{I}_{i \to j}} {l}_{ij} - {y}_{Uij} {A}_{{V}_{i \to j}} {V}_{i} - {y}_{Dij} {V}_{j} ) - {y}_{Cj} {V}_{j} + {I}_{j} = {\sum }_{k : j \to k} {I}_{j k} \qquad ( 7 )$$

where bus j has connected with an upstream branch i→j and a set of downstream branches j→k, Iᵢⱼ and Iⱼₖ are the complex currents flowing from bus i to bus j, and from bus j to bus k, and I is the complex injection current at bus j. y_{Dij} is the equivalent shunt admittance matrix of branch i→j at bus j, y_{cj} is the admittance matrix at bus j.

The third equation is a bus power injection equation defined as:

$$diag ( {V}_{j} {I}_{j}^{H} ) = {s}_{G , {Y}_{j}} - {s}_{L , {Y}_{j}} + {A}_{{S}_{D \to Y}} {s}_{G , {D}_{j}} - {A}_{{S}_{D \to Y}} {s}_{L , {D}_{j}} \qquad ( 8 )$$

where

$${I}_{j}^{H}$$

is the conjugate transpose of complex injected current at bus j, S_{G,Y}_{ⱼ} and S_{L,Y}_{ⱼ} are the wye-connected complex power generations and load demands at bus j, S_{G,D}_{ⱼ} and S_{L,D}_{ⱼ} are the delta-connected complex power generations and load demands at bus j, A_{S}_{_{D→Y}} is a complex power conversion matrix to convert powers from delta-connection to wye-connection.
(6) and (7) are linear equations, but (8) is a nonlinear equation.

Similarly, the equations (6)-(8) can also be separated into the real and reactive components to be solved.

### Optimal Phase Swapping Over a Finite Horizon T

In distribution networks, the diverse and predominantly ad-hoc allocation of single-phase renewable energy and electric vehicle charging installations leads to increased phase imbalances. These imbalances have the potential to negatively impact and introduce inefficiencies into the power distribution system. The subsequent rise in operational expenditures and the potential degradation of the network infrastructure underline the need for the development and implementation of optimized scheduling strategies. Phase swapping optimization becomes crucial to enhance the reliability and operational efficiency of distribution networks, ultimately lowering the operational costs.

The goal of phase swapping is to make the feeder “well-balanced” with minimal number of phase swapping and minimum operation cost increase for a given load, generation and per-unit cost profile over a scheduling cycle/horizon. Assumed each cycle has T time intervals, and the length of each interval is Δt. For example, a daily phasing swapping scheme includes 24 time steps, and each interval lasts 1.0 hours.

The optimal phase swapping aims to minimize a weighted sum of costs related to four objectives. The set of weight coefficients (ω^{SUB}, ω^{OVR}, ω^{IMB}, ω^{SWAP}) is selected based on the operational context and regulatory requirements, indicating the relative importance and economic implications of each cost component in achieving an optimal balance between production costs, system security, power quality, and device operations within the network constraints.

We assume any bus j can have three phases, and actual phase availability is defined using a vector of binary parameters,

$${A}_{BUS , j}^{ϕ} ( t ) , ϕ ∈ {Φ}_{Y} .$$

j can have three-phase wye-connected and delta-connected loads and generations allocated at three distinct wye-connected locations, and three distinct delta-connected locations.

$${s}_{L , {Y}_{j}}^{{l}_{Y}} ( t ) and {s}_{G , {Y}_{j}}^{{l}_{Y}} ( t )$$

are used to represent the forecasted load demands and generation productions at wye-connected location l_{γ} of bus j, respectively.

$${s}_{L , {D}_{j}}^{{l}_{D}} ( t ) and {s}_{G , {D}_{j}}^{{l}_{D}} ( t )$$

are used to represent the forecasted load demands and generation productions at delta-connected location l_{D} of bus j, respectively.

$${A}_{LOC , {Y}_{j}}^{{l}_{Y}} and {A}_{LOC , {D}_{j}}^{{l}_{D}}$$

are vectors of binary parameters representing the availability of wye-connected location l_{γ}, and the delta-connected location l_{D} of bus j. The actual phase connections for a bus jare determined based on location to phase assignment matrices and corresponding availabilities of locations. The matrix for assigning wye-connected locations to phases at bus j and time step t is expressed as

$$\{ {B}_{{Y}_{j}}^{{l}_{Y} \to {ϕ}_{Y}} ( t ) , {ϕ}_{Y} ∈ {Φ}_{Y} , {l}_{Y} ∈ {ℒ}_{Y} \} ,$$

and the matrix for assigning delta-connected locations to phase pairs at bus j and time step t is expressed as

$$\{ {B}_{{D}_{j}}^{{l}_{D} \to {ϕ}_{D}} ( t ) , {ϕ}_{D} ∈ {Φ}_{D} , {l}_{D} ∈ {ℒ}_{D} \} .$$

### Phase Swapping Formulation-I: Using Squared Voltage and Current Based Load Flow Formulation

The optimal problem for determining phase swapping actions over the given horizon can be formulated to minimize the cumulative cost over the scheduling horizon of T time steps while satisfying operational requirements for each time step t.

$$Minimize {\sum }_{t = 1}^{T} {J}^{SQ} ( t ) \qquad ( 9 )$$

The cost function for each time step t, J^{SQ} (t) is defined as a weighted sum of multiple cost components, including substation production (i.e., power purchase and generation and load curtailment) costs

$${C}_{tot}^{SUB} ( t ) ,$$

penalty costs for branch current and bus voltage limit violations

$${C}_{tot}^{OVR , SQ} ( t ) ,$$

penalty cost for load (power and current) and voltage imbalance

$${C}_{tot}^{IMB , SQ} ( t ) ,$$

and costs for phase swapping

$${C}_{tot}^{SWAP} ( t )$$

for the time interval:

$${J}^{SQ} ( t ) = {ω}^{SUB} {C}_{tot}^{SUB} ( t ) + {ω}^{OVR} {C}_{tot}^{OVR , SQ} ( t ) + {ω}^{IMB} {C}_{tot}^{IMB , SQ} ( t ) + {ω}^{SWAP} {C}_{tot}^{SWAP} ( t ) \qquad ( 10 )$$

$${C}_{tot}^{OVR , SQ} ( t ) and {C}_{tot}^{IMB , SQ} ( t )$$

are expressed in term of squared voltage and currents.

The cost function JSQ (t) includes the following components:

$$( 11 )$$

$${C}_{tot}^{SUB} ( t ) = {\sum }_{ϕ ∈ {Φ}_{Y}} ( {C}_{P}^{SUB} ( t ) Re ( {s}_{0}^{ϕ} ( t ) ) + {C}_{Q}^{SUB} ( t ) Im ( {s}_{0}^{ϕ} ( t ) ) ) + {\sum }_{j ∈ {𝒩}^{+}} {C}_{SG}^{CURT} ( t ) ( {\sum }_{{l}_{Y} ∈ {ℒ}_{Y}} {B}_{CURT , {Y}_{j}}^{{l}_{Y}} \vert {s}_{G , {Y}_{j}}^{{l}_{Y}} ( t ) \vert {A}_{LOC , {Y}_{j}}^{{l}_{Y}} + {\sum }_{{l}_{D} ∈ {ℒ}_{D}} {B}_{CURT , {Y}_{j}}^{{l}_{Y}} \vert {s}_{G , {D}_{j}}^{{l}_{D}} ( t ) \vert {A}_{LOC , {D}_{j}}^{{l}_{D}} ) + {\sum }_{j ∈ {𝒩}^{+}} {C}_{SL}^{CURT} ( t ) ( {\sum }_{{l}_{Y} ∈ {ℒ}_{Y}} {B}_{CURT , {Y}_{j}}^{{l}_{Y}} \vert {s}_{L , {Y}_{j}}^{{l}_{Y}} ( t ) \vert {A}_{LOC , {Y}_{j}}^{{l}_{Y}} + {\sum }_{{l}_{D} ∈ {ℒ}_{D}} {B}_{CURT , {D}_{j}}^{{l}_{D}} \vert {s}_{L ,}^{{l}_{D}} ( t ) \vert {A}_{LOC , {D}_{j}}^{{l}_{D}} )$$

$${C}_{tot}^{OVR , SQ} ( t ) = {\sum }_{i \to j ∈ ε} {\sum }_{ϕ ∈ {Φ}_{Y}} {C}_{Ĩ}^{OVR} ( t ) \vert Δ {\tilde{l}}_{max , ij}^{ϕ} ( t ) \vert + {\sum }_{i ∈ {𝒩}^{+}} {\sum }_{ϕ ∈ {Φ}_{Y}} ( {C}_{{\tilde{V}}_{max}}^{OVR} ( t ) \vert Δ {\tilde{V}}_{max , i}^{ϕ} ( t ) \vert + {C}_{{\tilde{V}}_{min}}^{OVR} ( t ) \vert Δ {\tilde{V}}_{min , i}^{ϕ} ( t ) \vert ) \qquad ( 12 )$$

$${C}_{tot}^{IMB , SQ} ( t ) = {\sum }_{ϕ ∈ {Φ}_{Y}} ( {C}_{P}^{IMB} ( t ) Re ( {IMB}_{s}^{ϕ} ( t ) ) + {C}_{Q}^{IMB} ( t ) Im ( {IMB}_{s}^{ϕ} ( t ) ) + {C}_{Ĩ}^{IMB} ( t ) {IMB}_{Ĩ}^{ϕ} ( t ) + {C}_{\tilde{V}}^{IMB} ( t ) {IMB}_{\tilde{V}}^{ϕ} ( t ) ) \qquad ( 13 )$$

$${C}_{tot}^{SWAP} ( t ) = {C}^{SWAP} ( t ) {n}_{sw ap} ( t ) \qquad ( 14 )$$

ω^{SUB} is a weight factor for total production costs including substation active and reactive power purchase costs, renewable generation curtailment costs, and load demand curtailment costs.

$${C}_{SG}^{SUB} ( t ) and {C}_{Q}^{SUB} ( t )$$

are the per unit active and reactive power purchase costs at the substation for the duration of time step t. It is assumed that phases are equally priced.

$${s}_{0}^{ϕ} ( t )$$

is the complex power fed from the substation at phase (and time step t and determined as:

$${s}_{0}^{ϕ} ( t ) = {\sum }_{0 : 0 \to i} diag ( {\tilde{S}}_{0 i}^{ϕ} ( t ) ) , ϕ ∈ {Φ}_{Y} \qquad ( 15 )$$

$${s}_{0} ( t ) = {[ {s}_{0}^{a} ( t ) , {s}_{0}^{b} ( t ) , {s}_{0}^{c} ( t ) ]}^{T} \cdot {\tilde{S}}_{0 i}^{ϕ} ( t )$$

is the expanded complex power flowing through the substation at bus 0 to downstream bus i.

$${C}_{SG}^{CURT} ( t ) and {C}_{SL}^{CURT} ( t )$$

are the per unit costs for generation and load curtailments for the duration of time step t.

$${B}_{CURT , {Y}_{j}}^{{l}_{Y}} ( t ) and {B}_{CURT , {D}_{j}}^{{l}_{D}} ( t )$$

are binary variables to represent the cut-off statuses of wye-connected location l_{γ} and delta-connection location l_{D} of bus j and time step t. If a connection is cut off, the connected generation and load at the location will be turn off, and generation and load curtailment costs are incurred. The feasibility of curtailments are constrained by the correspondingly availability of locations:

$${B}_{CURT , {Y}_{j}}^{{l}_{Y}} ( t ) = \{ 0 , 1 \} , {B}_{CURT , {Y}_{j}}^{{l}_{Y}} ( t ) \leq {A}_{LOC , {Y}_{j}}^{{l}_{Y}} , {l}_{Y} ∈ {ℒ}_{Y} , j ∈ {𝒩}^{+} \qquad ( 16 )$$

$${B}_{CURT , {D}_{j}}^{{l}_{D}} ( t ) = \{ 0 , 1 \} , {B}_{CURT , {D}_{j}}^{{l}_{D}} ( t ) \leq {A}_{LOC , {D}_{j}}^{{l}_{D}} , {l}_{D} ∈ {ℒ}_{D} , j ∈ {𝒩}^{+} \qquad ( 17 )$$

ω^{OVR} is a weight factor for total penalty costs for operational limit violations including branch current limits, bus maximum and minimum voltage limits.

$${C}_{I}^{OVR} ( t ) , {C}_{{V}_{max}}^{OVR} ( t ) and {C}_{{V}_{min}}^{OVR} ( t )$$

are the per unit penalty costs for squared current limit violation, maximum squared voltage limit violations, and minimum squared voltage limit violations for the duration of time step t.

$$Δ {\tilde{I}}_{max , ij}^{ϕ} ( t )$$

is the amount of squared current limit violation on branch (i, j), defined as:

$$diag ( {\tilde{I}}_{ij} ( t ) ) \leq {\tilde{I}}_{max , ij} + Δ {\tilde{I}}_{max , ij} ( t ) , ( i , j ) ∈ ε \qquad ( 18 )$$

where

$${\tilde{I}}_{max , ij} = {[ {( {I}_{max , ij}^{a} )}^{2} , {( {I}_{max , ij}^{b} )}^{2} , {( {I}_{max , ij}^{c} )}^{2} ]}^{T} ,$$

$$Δ {\tilde{I}}_{max , ij} = {[ Δ {\tilde{I}}_{max , ij}^{a} , Δ {\tilde{I}}_{max , ij}^{b} , Δ {\tilde{I}}_{max , ij}^{c} ]}^{T} , {I}_{max , ij}^{ϕ} .$$

is the limit of current on phase ϕ of branch (i,j).

$$Δ {\tilde{V}}_{max , i}^{ϕ} ( t ) , and Δ {\tilde{V}}_{min , i}^{ϕ}$$

are the amounts of maximum and minimum squared voltage limit violations at phase ϕ of bus i and time step t, and determined as:

$${\tilde{V}}_{min , i} - Δ {\tilde{V}}_{min , i} ( t ) \leq diag ( {\tilde{V}}_{i} ( t ) ) \leq {\tilde{V}}_{max , i} + Δ {\tilde{V}}_{max , i} ( t ) , i ∈ {𝒩}^{+} \qquad ( 19 )$$

where

$${\tilde{V}}_{max , i} = {[ {( {V}_{max , i}^{a} )}^{2} , {( {V}_{max , i}^{b} )}^{2} , {( {V}_{max , i}^{c} )}^{2} ]}^{T} , and$$

$${\tilde{V}}_{min , i} = {[ {( {V}_{min , i}^{a} )}^{2} , {( {V}_{min , i}^{b} )}^{2} , {( {V}_{min , i}^{c} )}^{2} ]}^{T} , {V}_{max , i}^{ϕ} and {V}_{min , i}^{ϕ}$$

are the upper and lower limits of voltages on phase ϕ of bus i,

$$Δ {\tilde{V}}_{max , i} = {[ Δ {\tilde{V}}_{max , i}^{a} , Δ {\tilde{V}}_{max , i}^{b} , Δ {\tilde{V}}_{max , i}^{c} ]}^{T} , and$$

$$Δ {\tilde{V}}_{min , i} = {[ Δ {\tilde{V}}_{min , i}^{a} , Δ {\tilde{V}}_{min , i}^{b} , Δ {\tilde{V}}_{min , i}^{c} ]}^{T} .$$

ω^{IMB} is a weight factor for total penalty costs for phase imbalances including substation active and reactive power phase imbalances, substation current phase imbalances, and system maximum voltage phase imbalances. The penalty costs for phase imbalances are not directly related to real-time operation/dispatch, but phase swapping we would like to impose in our objective function implication of a constraint that along each phase, we want the magnitude of power, current or voltage to be as close as possible to a one third of total power, current or voltage.

$${C}_{P}^{IMB} ( t ) and {C}_{Q}^{IMB} ( t )$$

are the per unit costs for active power and reactive power imbalance penalty for the duration of time step t.

$${IMB}_{s}^{ϕ} ( t )$$

is the complex power imbalance on phase ϕ at time step t, and determined as:

$${IMB}_{s}^{ϕ} ( t ) = {s}_{0}^{ϕ} ( t ) - \frac{1}{3} {\sum }_{ϕ ∈ {Φ}_{Y}} {s}_{0}^{ϕ} ( t ) , ϕ ∈ {Φ}_{Y} \qquad ( 20 )$$

$${C}_{Ĩ}^{IMB} ( t )$$

is the per unit cost of squared current imbalance for the duration of time step t, and

$${IMB}_{Ĩ}^{ϕ} ( t )$$

is squared current imbalance for phase ϕ at time step t defined as:

$${I}_{s q , 0} ( t ) = diag ( {\sum }_{0 : 0 \to i} {\tilde{I}}_{0 i} ( t ) ) , ϕ ∈ {Φ}_{Y} \qquad ( 21 )$$

$${IMB}_{\tilde{I}}^{ϕ} ( t ) = ‖ {I}_{sq , 0}^{ϕ} ( t ) \vert - \frac{1}{3} {\sum }_{ϕ ∈ {Φ}_{Y}} \vert {I}_{sq , 0}^{ϕ} ( t ) ‖ , ϕ ∈ {Φ}_{Y} \qquad ( 22 )$$

$${I}_{s q , 0} ( t ) = {[ {I}_{sq , 0}^{a} ( t ) , {I}_{sq , 0}^{b} ( t ) , {I}_{sq , 0}^{c} ( t ) ]}^{T} , {I}_{sq , 0}^{ϕ} ( t )$$

is the squared current flowing on phase ϕ at the substation.

$${C}_{\tilde{V}}^{IMB} ( t )$$

is per unit cost of squared voltage at time step t.

$${IMB}_{\tilde{V}}^{ϕ} ( t )$$

is the system maximum squared voltage imbalance on phase ϕ at time step t, and defined as:

$${IMB}_{\tilde{V}}^{ϕ} ( t ) = {max}_{j ∈ {𝒩}^{+}} \vert \vert {\tilde{{V}_{j}}}^{ϕ} ( t ) \vert - \frac{1}{{\sum }_{ϕ ∈ {Φ}_{Y}} {A}_{{BUS}_{j}}^{ϕ}} {\sum }_{ϕ ∈ {Φ}_{Y}} \vert {\tilde{{V}_{j}}}^{ϕ} ( t ) \vert {A}_{{BUS}_{j}}^{ϕ} \vert , \qquad ( 23 )$$

$$ϕ ∈ {Φ}_{Y} ,$$

$${A}_{{BUS}_{j}}^{ϕ}$$

is a binary parameter representing the phase availability of phase ϕ at bus j.

$${\tilde{{V}_{j}}}^{ϕ} ( t )$$

is the squared voltage of phase ϕ of bus j.

ω^{SWAP} is a weight factor relating to the total costs for phase swapping numbers. Since each phase swapping operation is associated with certain costs on lineman expenses, maintenance expenses, and planned outage duration if phase swapping is implemented manually, or recovered investment cost, and expected outage cost if implemented automatically. We could not afford to swap phases for all number at all the time. The number of phase swapping n_{swap} (t) for time step t need to be compromised between benefits and costs. The cost per phase swapping at time step t is pre-determined as C^{SWAP}(t). n_{swap} (t) is defined as:

$${n}_{sw ap} ( t ) = {\sum }_{j ∈ {𝒩}^{+}} {n}_{swap , j} ( t ) , \qquad ( 24 )$$

$${n}_{swap , j} ( t ) = ( {\sum }_{{l}_{Y} ∈ {ℒ}_{Y}} {A}_{LOC , {Y}_{j}}^{{l}_{Y}} - {\sum }_{{l}_{Y} ∈ {ℒ}_{Y}} {B}_{CURT , {Y}_{j}}^{{l}_{Y}} ( t ) - {\sum }_{{ϕ}_{Y} ∈ {Φ}_{Y}} {\sum }_{{l}_{Y} ∈ {ℒ}_{Y}} {B}_{{Y}_{j}}^{{l}_{Y} \to {ϕ}_{Y}} ( t ) {B}_{{Y}_{j}}^{{l}_{Y} \to {ϕ}_{Y}} ( t - 1 ) ) + ( {\sum }_{{l}_{D} ∈ {ℒ}_{D}} {A}_{LOC , {Y}_{j}}^{{l}_{D}} - {\sum }_{{l}_{D} ∈ {ℒ}_{D}} {B}_{CURT , {D}_{j}}^{{l}_{D}} ( t ) - {\sum }_{{ϕ}_{D} ∈ {Φ}_{D}} {\sum }_{{l}_{D} ∈ {ℒ}_{D}} {B}_{{D}_{j}}^{{l}_{D} \to {ϕ}_{D}} ( t ) {B}_{{D}_{j}}^{{l}_{D} \to {ϕ}_{D}} ( t - 1 ) ) , \qquad ( 25 )$$

$$j ∈ {𝒩}^{+}$$

$${B}_{{Y}_{j}}^{{l}_{Y} \to {ϕ}_{Y}} ( t ) = \{ 0 , 1 \} , {ϕ}_{Y} ∈ {Φ}_{Y} , {l}_{Y} ∈ {ℒ}_{Y} , j ∈ {𝒩}^{+} \qquad ( 26 )$$

$${B}_{{D}_{j}}^{{l}_{D} \to {ϕ}_{D}} ( t ) = \{ 0 , 1 \} , {ϕ}_{D} ∈ {Φ}_{D} , {l}_{D} ∈ {ℒ}_{D} , j ∈ {𝒩}^{+} \qquad ( 27 )$$

$${B}_{{Y}_{j}}^{{l}_{Y} \to {ϕ}_{Y}} ( t )$$

is a binary variable representing status for assigning phase ϕ_{γ}∈Φ_{γ} to location l_{γ}∈ [symbol] _{γ} at bus j at time step t.

$${B}_{{D}_{j}}^{{l}_{D} \to {ϕ}_{D}} ( t )$$

is a binary variable representing status for assigning phase-pair ϕ_{D}∈Φ_{D} to location l_{D}∈ [symbol] _{D} at bus j at time step t. Those two sets of variables are used to represent phase swapping actions.

The technical constraints must be satisfied for each time step t include load flow equations, substation voltage settings, and phase swapping feasibility constraints.

Considering the impacts of phase swapping actions, the squared voltage and current based load flow equations at time step t are expressed as:

$${\sum }_{i : i \to j} diag ( {A}_{{V}_{i \to j}} {\tilde{S}}_{ij} ( t ) {A}_{{I}_{i \to j}}^{H} - {A}_{{V}_{i \to j}} {\tilde{V}}_{i} ( t ) {A}_{{V}_{i \to j}}^{H} {y}_{Uij}^{H} - {\tilde{V}}_{j} ( t ) {y}_{Dij}^{H} + {z}_{ij} {y}_{Uij} {A}_{{V}_{i \to j}} {\tilde{S}}_{ij} ( t ) {A}_{{I}_{i \to j}}^{H} - {z}_{ij} {y}_{Uij} {A}_{{V}_{i \to j}} {\tilde{V}}_{i} ( t ) {A}_{{V}_{i \to j}}^{H} {y}_{Uij}^{H} + {z}_{ij} {A}_{{I}_{i \to j}} {\tilde{S}}_{ij}^{H} ( t ) {A}_{{V}_{i \to j}}^{H} {y}_{Uij}^{H} - {z}_{ij} {A}_{{I}_{i \to j}} {\tilde{I}}_{ij}^{H} ( t ) {A}_{{I}_{i \to j}}^{H} ) - diag ( {\tilde{V}}_{j} ( t ) {y}_{Cj}^{H} ) + {s}_{j} ( t ) = {\sum }_{k : j \to k} diag ( {S}_{jk} ( t ) ) , \qquad ( 28 )$$

$$j ∈ {N}^{+}$$

$${s}_{j}^{ϕ} ( t ) = {\sum }_{{l}_{Y} ∈ {ℒ}_{Y}} {B}_{{Y}_{j}}^{{l}_{Y} \to ϕ} ( t ) ( {s}_{G , {Y}_{j}}^{{l}_{Y}} ( t ) - {s}_{L , {Y}_{j}}^{{l}_{Y}} ( t ) ) + {\sum }_{{ϕ}_{D} ∈ {Φ}_{D}} {A}_{{S}_{D \to Y}}^{ϕ , {ϕ}_{D}} {\sum }_{{l}_{D} ∈ {ℒ}_{D}} {B}_{{D}_{j}}^{{l}_{D} \to {ϕ}_{D}} ( t ) ( {s}_{G , {D}_{j}}^{{l}_{D}} ( t ) - {s}_{L , {D}_{j}}^{{l}_{D}} ( t ) ) , \qquad ( 29 )$$

$$ϕ ∈ {Φ}_{Y} , j ∈ {𝒩}^{+}$$

$${A}_{{V}_{i \to j}} {\tilde{V}}_{i} ( t ) {A}_{{V}_{i \to j}}^{H} - {\tilde{V}}_{j} ( t ) = {A}_{{V}_{i \to j}} {\tilde{S}}_{ij} ( t ) {A}_{{I}_{i \to j}}^{H} {z}_{ij}^{H} - {A}_{{V}_{i \to j}} {\tilde{V}}_{i} ( t ) {A}_{{V}_{i \to j}}^{H} {y}_{Uij}^{H} {z}_{ij}^{H} + {z}_{ij} {A}_{{I}_{i \to j}} {\tilde{S}}_{ij}^{H} ( t ) {A}_{{V}_{i \to j}}^{H} - {z}_{ij} {A}_{{I}_{i \to j}} {\tilde{I}}_{ij} ( t ) {A}_{{I}_{i \to j}}^{H} {z}_{ij}^{H} + {z}_{ij} {A}_{{I}_{i \to j}} {\tilde{S}}_{ij}^{H} ( t ) {A}_{{V}_{i \to j}}^{H} {y}_{Uij}^{H} {z}_{ij}^{H} - {z}_{ij} {y}_{Uij} {A}_{{V}_{i \to j}} {\tilde{V}}_{i} ( t ) {A}_{{y}_{i \to j}}^{H} + {z}_{ij} {y}_{Uij} {A}_{{V}_{i \to j}} {\tilde{S}}_{ij} ( t ) {A}_{{I}_{i \to j}}^{H} {z}_{ij}^{H} - {z}_{ij} {y}_{Uij} {A}_{{V}_{i \to j}} {\tilde{V}}_{i} ( t ) {A}_{{V}_{i \to j}}^{H} {y}_{Uij}^{H} {z}_{ij}^{H} , \qquad ( 30 )$$

$$( i , j ) ∈ E$$

$${\tilde{V}}_{i} ( t ) {\tilde{I}}_{ij} ( t ) - {\tilde{S}}_{ij} ( t ) {\tilde{S}}_{ij}^{H} ( t ) \geq 0 , ( i , j ) ∈ ε \qquad ( 31 )$$

where

$${A}_{{S}_{D \to Y}} = {( {A}_{{S}_{D \to Y}}^{ϕ , {ϕ}_{D}} )}_{3 \times 3} , and {A}_{{S}_{D \to Y}}^{ϕ , {ϕ}_{D}}$$

is the element of A_{S}_{_{D→Y}} coresponing to row ϕ and column Φ_{D}.

The substation voltage is fixed, and expressed as:

$${\tilde{V}}_{0} ( t ) = {V}_{0}^{ref} ( t ) {( {V}_{0}^{ref} ( t ) )}^{H} \qquad ( 32 )$$

where

$${V}_{0}^{ref} ( t )$$

is the vector of given substation three-phase voltages at time step t.

The assignment matrix for wye-connected loads or generations must satisfy that each location is assigned to at most one phase, and each phase is assigned to at most one location:

$${B}_{CURT , {Y}_{j}}^{{l}_{Y}} + {\sum }_{{ϕ}_{Y} ∈ {Φ}_{Y}} {B}_{{Y}_{j}}^{{l}_{Y} \to {ϕ}_{Y}} ( t ) = {A}_{LOC , {Y}_{j}}^{{l}_{Y}} , {l}_{Y} ∈ {ℒ}_{Y} , j ∈ {𝒩}^{+} \qquad ( 33 )$$

$${\sum }_{{l}_{Y} ∈ {ℒ}_{Y}} {B}_{{Y}_{j}}^{{l}_{Y} \to {ϕ}_{Y}} ( t ) \leq 1 , {ϕ}_{Y} ∈ {Φ}_{Y} , j ∈ {𝒩}^{+} \qquad ( 34 )$$

Where parameter

$${A}_{LOC , {Y}_{j}}^{{l}_{Y}}$$

indicates the availability of load/generation at location l_{γ} at bus j.

Similarly, the assignment matrix for delta-connected loads or generations must satisfy that each location is assigned to at most one phase-pair, and each phase-pair is assigned to at most one location:

$${B}_{CURT , {D}_{j}}^{{l}_{D}} + {\sum }_{{ϕ}_{D} ∈ {Φ}_{D}} {B}_{{D}_{j}}^{{l}_{D} \to {ϕ}_{D}} ( t ) = {A}_{LOC , {D}_{j}}^{{l}_{D}} , {l}_{D} ∈ {ℒ}_{D} , j ∈ {𝒩}^{+} \qquad ( 35 )$$

$${\sum }_{{l}_{D} ∈ {ℒ}_{D}} {B}_{{D}_{j}}^{{l}_{D} \to {ϕ}_{D}} ( t ) \leq 1 , {ϕ}_{D} ∈ {Φ}_{D} , j ∈ {𝒩}^{+} \qquad ( 36 )$$

where

$${A}_{LOC , {D}_{j}}^{{l}_{D}}$$

indicates the availability of load/generation at location l_{D} at bus j.

In summary, the optimal phase swapping problem can formulate as a mixed integer nonlinear programming problem (37), according to:

$$\begin{matrix}( 1 ) & \\ Minimize {\sum }_{t = 1}^{T} {J}^{SQ} ( t ) & ( 37 a )\end{matrix}$$

$$Subject to :$$

$$constraints expressed as ( 10 ) ∼ ( 36 ) , t = 1 , 2 , … , T \qquad ( 37 b )$$

### Phase Swapping Formulation-II: Using Explicit Voltage and Current Based Load Flow Formulation

Similarly, we can also use explicit voltage and current based load flow model to formulate phase swapping optimization over the finite horizon.

The cost function to be minimized can be expressed as:

$$Minimize {\sum }_{t = 1}^{T} {J}^{EXP} ( t ) \qquad ( 38 )$$

J^{EXP}(t) is the cost function for each time step t, and can be expressed based on explicit voltages and currents as:

$${J}^{EXP} ( t ) = {ω}^{SUB} {C}_{tot}^{SUB} ( t ) + {ω}^{OVR} {C}_{tot}^{OVR , EXP} ( t ) + {ω}^{IMB} {C}_{tot}^{IMB , EXP} ( t ) + {ω}^{SWAP} {C}_{tot}^{SWAP} ( t ) \qquad ( 39 )$$

This cost function is defined as a weighted sum of four different groups of cost components

$${C}_{tot}^{SUB} ( t ) , {C}_{tot}^{OVR , EXP} ( t ) , {C}_{tot}^{IMB , EXP} ( t ) and {C}_{tot}^{SWAP}$$

with a pre-given weight parameter set {ω^{SUB}, ω^{OVR}, ω^{IMB}, ω^{SWAP}}.

The first cost group,

$${C}_{tot}^{SUB} ( t )$$

is associated to operational costs for generating powers met demands, including total active and reactive power purchase costs at the substation, and load and generation curtailment costs at all buses. It is defined as:

$$( 40 )$$

$${C}_{tot}^{SUB} ( t ) = {\sum }_{ϕ ∈ {Φ}_{Y}} ( {C}_{P}^{SUB} ( t ) Re ( {s}_{0}^{ϕ} ( t ) ) + {C}_{Q}^{SUB} ( t ) Im ( {s}_{0}^{ϕ} ( t ) ) ) + {\sum }_{j ∈ {𝒩}^{+}} {C}_{SG}^{CURT} ( t ) \text{} ( {\sum }_{{l}_{Y} ∈ {ℒ}_{Y}} {B}_{CURT , {Y}_{j}}^{{l}_{Y}} \vert {s}_{G , {Y}_{j}}^{{l}_{Y}} ( t ) \vert {A}_{L O C , {Y}_{j}}^{{l}_{Y}} + {\sum }_{{l}_{D} ∈ {ℒ}_{D}} {B}_{CURT , {D}_{j}}^{{l}_{D}} \vert {s}_{G , {D}_{j}}^{{l}_{D}} ( t ) \vert {A}_{LOC , {D}_{j}}^{{l}_{D}} ) + {\sum }_{j ∈ {𝒩}^{+}} {C}_{SL}^{CURT} ( \text{} t ) \text{} ( {\sum }_{{l}_{Y} ∈ {ℒ}_{Y}} {B}_{CURT , {Y}_{j}}^{{l}_{Y}} \vert {s}_{L , {Y}_{j}}^{{l}_{Y}} ( t ) \vert {A}_{L O C , {Y}_{j}}^{{l}_{Y}} + {\sum }_{{l}_{D} ∈ {ℒ}_{D}} {B}_{CURT , {D}_{j}}^{{l}_{D}} \vert {s}_{L , {D}_{j}}^{{l}_{D}} ( t ) \vert {A}_{LOC , {D}_{j}}^{{l}_{D}} )$$

The active and reactive power purchase costs are calculated based on complex power fed from the substation for each time step t,

$${s}_{0}^{ϕ} ( t ) ,$$

ϕ∈Φ_{γ} and corresponding per-unit cost coefficients for active and reactive power purchase,

$${C}_{P}^{G} ( t ) and {C}_{Q}^{G} ( t ) .$$

$${s}_{0}^{ϕ} ( t ) = {\sum }_{0 : 0 \to i} {V}_{0}^{ϕ} ( t ) {( {I}_{0 i}^{ϕ} ( t ) )}^{H} , ϕ ∈ {Φ}_{Y} \qquad ( 41 )$$

$${I}_{0 i}^{ϕ} ( t )$$

is the complex current flowing through the substation at bus 0 to downstream bus i on phase ϕ,

$${V}_{0}^{ϕ} ( t )$$

is the complex voltage at the substation on phase ϕ. The load/generation curtailment costs for any bus j are calculated based on per-unit cost coefficients for load/generation curtailments,

$${C}_{SL}^{CURT} ( t ) / {C}_{SG}^{CURT} ( t ) .$$

The full load or generation at location l_{γ} or l_{D} is cut off if corresponding wye or delta connection curtailment status,

$${B}_{CURT , {Y}_{j}}^{{l}_{Y}} or {B}_{CURT , {D}_{j}}^{{l}_{D}}$$

is determined as 1. The feasibility constraints of load/generation curtailment variables for bus j at time step t are expressed as:

$${B}_{CURT , {Y}_{j}}^{{l}_{Y}} ( t ) = \{ 0 , 1 \} , {B}_{CURT , {Y}_{j}}^{{l}_{Y}} ( t ) \leq {A}_{LOC , {Y}_{j}}^{{l}_{Y}} , {l}_{Y} ∈ {ℒ}_{Y} , j ∈ {𝒩}^{+} \qquad ( 42 )$$

$${B}_{CURT , {D}_{j}}^{{l}_{D}} ( t ) = \{ 0 , 1 \} , {B}_{CURT , {D}_{j}}^{{l}_{D}} ( t ) \leq {A}_{LOC , {D}_{j}}^{{l}_{D}} , {l}_{D} ∈ {ℒ}_{D} , j ∈ {𝒩}^{+} \qquad ( 43 )$$

The curtailment statuses are limited to the availability statues of connection location l_{γ}, and l_{D},

$${A}_{LOC , {Y}_{j}}^{{l}_{Y}} , {A}_{L O C , {D}_{j}}^{{l}_{D}} .$$

The second cost group,

$${C}_{tot}^{OVR , EXP} ( t )$$

quantifies the penalizing costs for branch current violating its thermal threshold or bus voltage violating its lower or upper thresholds, and defined as:

$$\begin{matrix}{C}_{tot}^{OVR , EXP} ( t ) = {\sum }_{i \to j ∈ ε} {\sum }_{ϕ ∈ {Φ}_{Y}} {C}_{I}^{OVR} ( t ) Δ {I}_{max , ij}^{ϕ} ( t ) \\ + {\sum }_{i ∈ {𝒩}^{+}} {\sum }_{ϕ ∈ {Φ}_{Y}} ( {C}_{{V}_{max}}^{OVR} ( t ) Δ {V}_{max , i}^{ϕ} ( t ) + {C}_{{V}_{min}}^{OVR} ( t ) Δ {V}_{min , i}^{ϕ} ( t ) )\end{matrix} \qquad ( 44 )$$

$${C}_{I}^{OVR} ( t )$$

is per unit cost for branch current overlimit at time step t,

$$Δ {I}_{max , ij}^{ϕ} ( t )$$

is branch current overlimit (i.e. limit violation) and determined as:

$$\vert {I}_{{I}_{ij}}^{ϕ} \vert \leq {\overline{I}}_{ij}^{ϕ} + Δ {I}_{max , ij}^{ϕ} ( t ) , ϕ ∈ {Φ}_{Y} , ( i , j ) ∈ ε \qquad ( 45 )$$

where

$$\vert {I}_{{I}_{ij}}^{ϕ} \vert$$

is the absolute value of complex current

$${I}_{{I}_{ij}}^{ϕ} , {\overline{I}}_{ij}^{ϕ}$$

is the upper limit of current on phase ϕ of branch (i, j).

$${C}_{{V}_{max}}^{OVR} ( t ) and {C}_{{V}_{min}}^{OVR} ( t )$$

are per unit voltage upper and lower limit violation cost at time step t, and

$$Δ {V}_{max , j}^{ϕ} ( t ) and Δ {V}_{min , j}^{ϕ} ( t )$$

are the voltage upper and lower limit violations at bus j and determined as:

$${V}_{min , j} - Δ {V}_{min , j}^{ϕ} ( t ) \leq \vert {V}_{j}^{ϕ} ( t ) \vert \leq {V}_{max , j} + Δ {V}_{max , j}^{ϕ} ( t ) , j ∈ {𝒩}^{+} \qquad ( 46 )$$

V_{max,j} and V_{min,j} are the upper and lower limits of voltages on phase ϕ of bus j.

The third cost group,

$${C}_{tot}^{IMB , EXP}$$

captures the costs for penalizing load (active and reactive power, current) and voltage deviations from ideal balance.

$${C}_{tot}^{IMB , EXP} = {\sum }_{ϕ ∈ {Φ}_{Y}} ( {C}_{P}^{IMB} ( t ) \vert Re ( {IMB}_{s}^{ϕ} ( t ) ) \vert + {C}_{Q}^{IMB} ( t ) \vert Im ( {IMB}_{s}^{ϕ} ( t ) ) \vert + {C}_{I}^{IMB} ( t ) {IMB}_{I}^{ϕ} ( t ) + {C}_{V}^{IMB} ( t ) {IMB}_{V}^{ϕ} ( t ) ) Δ t \qquad ( 47 )$$

$${C}_{P}^{IMB} ( t ) , {C}_{Q}^{IMB} ( t ) , {C}_{I}^{IMB} ( t ) and {C}_{V}^{IMB} ( t )$$

are cost efficients penalizing active power, reactive power, current deviations at the substation among phases, and maximum voltage phase deviation among all buses.

$${IMB}_{s}^{ϕ} ( t )$$

is the load imbalance at substation on phase ϕ of time step t, and determined as:

$${IMB}_{s}^{ϕ} ( t ) = {s}_{0}^{ϕ} ( t ) - \frac{1}{3} {\sum }_{ϕ ∈ {Φ}_{Y}} {s}_{0}^{ϕ} ( t ) , ϕ ∈ {Φ}_{Y} \qquad ( 48 )$$

$${IMB}_{I}^{ϕ} ( t )$$

is the maximum current imbalance at the substation for phase ϕ,

$${IMB}_{I}^{ϕ} ( t ) :$$

$${IMB}_{I}^{ϕ} ( t ) = {max}_{i ∈ {𝒩}_{o}} \vert \vert {I}_{0 i}^{ϕ} ( t ) \vert - \frac{1}{3} {\sum }_{ϕ ∈ {Φ}_{Y}} \vert {I}_{0 i}^{ϕ} ( t ) \vert \vert , ϕ ∈ {Φ}_{Y} \qquad ( 49 )$$

[symbol]

is the bus set of downstream buses of the substation.

$${IMB}_{V}^{ϕ} ( t )$$

is the maximum voltage imbalance on phase ϕ over all buses downstream to the substation:

$${IMB}_{V}^{ϕ} ( t ) = {max}_{j ∈ {𝒩}^{+}} \vert \vert {V}_{j}^{ϕ} ( t ) \vert - \frac{1}{{\sum }_{ϕ ∈ {Φ}_{Y}} {A}_{{BUS}_{j}}^{ϕ}} {\sum }_{ϕ ∈ {Φ}_{Y}} \vert {V}_{j}^{ϕ} ( t ) \vert {A}_{{BUS}_{j}}^{ϕ} \vert , ϕ ∈ {Φ}_{Y} \qquad ( 50 )$$

where each bus may have three phases,

$${A}_{{BUS}_{j}}^{ϕ}$$

represent the availability of phase ϕ at bus j.

The fourth cost group,

$${C}_{tot}^{SWAP} ( t )$$

is relating to the phase swapping times, and defined as:

$${C}_{tot}^{SWAP} ( t ) = {C}^{SWAP} {n}_{swap} ( t ) \qquad ( 51 )$$

C^{SWAP} is the cost per phase swapping, n_{swap}(t) is the total number of phase swapping at time step t and defined based phase swapping actions for each swappable bus j, n_{swap,j} (t) using assignment matrices of locations to phases (or phase pairs) as:

$${n}_{swap} ( t ) = {\sum }_{j ∈ {𝒩}^{+}} {n}_{swap , j} ( t ) , \qquad ( 52 )$$

$${n}_{swap , j} ( t ) = ( {\sum }_{{l}_{Y} ∈ {ℒ}_{Y}} {A}_{L O C , {Y}_{j}}^{{l}_{Y}} - {\sum }_{{l}_{Y} ∈ {ℒ}_{Y}} {B}_{CURT , {Y}_{j}}^{{l}_{Y}} - {\sum }_{{ϕ}_{Y} ∈ {Φ}_{Y}} {\sum }_{{l}_{Y} ∈ {ℒ}_{Y}} {B}_{{Y}_{j}}^{{l}_{Y} \to {ϕ}_{Y}} ( t ) {B}_{{Y}_{j}}^{{l}_{Y} \to {ϕ}_{Y}} ( t - 1 ) ) + ( {\sum }_{{l}_{D} ∈ {ℒ}_{D}} {A}_{LOC , {D}_{j}}^{{l}_{D}} - {\sum }_{{l}_{D} ∈ {ℒ}_{D}} {B}_{CURT , {D}_{j}}^{{l}_{D}} - {\sum }_{{ϕ}_{D} ∈ {Φ}_{D}} {\sum }_{{l}_{D} ∈ {ℒ}_{D}} {B}_{{D}_{j}}^{{l}_{D} \to {ϕ}_{D}} ( t ) {B}_{{D}_{j}}^{{l}_{D} \to {ϕ}_{D}} ( t - 1 ) ) , j ∈ {𝒩}^{+} \qquad ( 53 )$$

$${B}_{{Y}_{j}}^{{l}_{Y} \to {ϕ}_{Y}} ( t ) = \{ 0 , 1 \} , j ∈ {𝒩}^{+} , {ϕ}_{Y} ∈ {Φ}_{Y} {l}_{Y} ∈ {ℒ}_{Y} \qquad ( 54 )$$

$${B}_{{D}_{j}}^{{l}_{D} \to {ϕ}_{D}} ( t ) = \{ 0 , 1 \} , j ∈ {𝒩}^{+} , {ϕ}_{D} ∈ {Φ}_{D} , {l}_{D} ∈ {ℒ}_{D} \qquad ( 55 )$$

The optimal phase swapping scheme for all time steps within the scheduling horizon is determined by minimizing the cumulative cost function (38) while satisfying a set of technical requirements, including load flow equations explicitly expressed using bus voltage and branch current, substation voltage settings, and swapping feasibility constraints.

Taken into account of phase swapping, the branch flow based load flow model can be expressed using bus voltage and branch currents as:

$${A}_{{V}_{i \to j}} {V}_{i} ( t ) - {V}_{j} ( t ) = {z}_{i j} ( {A}_{{I}_{i \to j}} {I}_{i j} ( t ) - {y}_{U i j} {A}_{{V}_{i \to j}} {V}_{i} ( t ) ) , \qquad ( 56 )$$

$${\sum }_{i : i \to j} ( {A}_{{I}_{i \to j}} {I}_{i j} ( t ) - {y}_{Uij} {A}_{{V}_{i \to j}} {V}_{i} ( t ) - {y}_{Dij} {V}_{j} ( t ) ) - {y}_{Cj} {V}_{j} ( t ) + {I}_{j} ( t ) = {\sum }_{k : j \to k} {I}_{j k} ( t ) , ( i , j ) ∈ ε \qquad ( 57 )$$

$${V}_{j}^{ϕ} ( t ) {( {I}_{j}^{ϕ} ( t ) )}^{*} = {\sum }_{{l}_{Y} ∈ {ℒ}_{Y}} {B}_{{Y}_{j}}^{{l}_{Y} \to ϕ} ( t ) ( {s}_{G , {Y}_{j}}^{{l}_{Y}} ( t ) - {s}_{L , {Y}_{j}}^{{l}_{Y}} ( t ) ) + {\sum }_{{ϕ}_{D} ∈ {ϕ}_{D}} {A}_{{S}_{D \to Y}}^{ϕ , {ϕ}_{D}} {\sum }_{{l}_{D} ∈ {ℒ}_{D}} {B}_{{D}_{j}}^{{l}_{D} \to {ϕ}_{D}} ( t ) ( {s}_{G , {D}_{j}}^{{l}_{D}} ( t ) - {s}_{L , {D}_{j}}^{{l}_{D}} ( t ) ) , ϕ ∈ {Φ}_{Y} , j ∈ {𝒩}^{+} \qquad ( 58 )$$

The substation voltage is fixed:

$${V}_{0} ( t ) = {V}_{0}^{ref} ( t ) , \qquad ( 59 )$$

Where

$${V}_{0}^{ref} ( t )$$

is given substation three-phase voltages at time step t.

To maintain the feasibility of the assignment matrix for wye-connected and delta-connected loads or generations, it is required that the assignment matrix for wye-connected loads or generations must satisfy that each available location is only assigned to one phase, and each phase is assigned no more than 1 of available location, and the assignment matrix for delta-connected loads or generations must satisfy that each available location is only assigned to one phase pair, and each phase pair is assigned no more than 1 of available location:

$${A}_{CURT , {Y}_{j}}^{{l}_{Y}} + {\sum }_{{ϕ}_{Y} ∈ {Φ}_{Y}} {B}_{{Y}_{j}}^{{l}_{Y} \to {ϕ}_{Y}} ( t ) = {A}_{L O C , {Y}_{j}}^{{l}_{Y}} , {l}_{Y} ∈ {ℒ}_{Y} , j ∈ {𝒩}^{+} \qquad ( 60 )$$

$${\sum }_{{l}_{Y} ∈ {ℒ}_{Y}} {B}_{{Y}_{j}}^{{l}_{Y} \to {ϕ}_{Y}} ( t ) \leq 1 , {ϕ}_{Y} ∈ {Φ}_{Y} , i ∈ {𝒩}^{+} \qquad ( 61 )$$

$${A}_{CURT , {D}_{j}}^{{l}_{D}} + {\sum }_{{ϕ}_{D} ∈ {Φ}_{D}} {B}_{{D}_{j}}^{{l}_{D} \to {ϕ}_{D}} ( t ) = {A}_{LOC , {D}_{j}}^{{l}_{D}} , {l}_{D} ∈ {ℒ}_{D} , j ∈ {𝒩}^{+} \qquad ( 62 )$$

$${\sum }_{{l}_{D} ∈ {ℒ}_{D}} {B}_{{D}_{j}}^{{l}_{D} \to {ϕ}_{D}} ( t ) \leq 1 , {ϕ}_{D} ∈ {Φ}_{D} , i ∈ {𝒩}^{+} \qquad ( 63 )$$

To summarize the above-described branch currents and bus voltages based formulation, a multi-step phase swapping optimization can be formulated as an mixed integer nonlinear programming problem (64), according to:

$$\begin{matrix}( 1 ) & \\ Minimize {\sum }_{t = 1}^{T} {J}^{EXP} ( t ) & ( 64 a )\end{matrix}$$

$$Subject to :$$

$$constraints expresssed as ( 38 ) \sim ( 63 ) , t = 1 , 2 , … , T \qquad ( 64 b )$$

As shown either in formulation-I or formulation-II, the phase swapping scheduling over a fine horizon is a mixed-integer nonlinear programming problem. We can determine an optimal scheme for phase swapping for each time step based on the solution of the formulated problem. The solution for n_{swap}(t) provides the total number of phase connection changes for the horizon, and n_{swap},l(t) gives the number of phase swapping at bus j at time step t. If n_{swap} (t)>0, a phase swapping is required for time step t, otherwise no phase swapping is needed. The detailed connection changes for any bus j∈ [symbol] ⁺ for time step t are given by the instance differences of phase-location-assignment matrices,

$$\{ {B}_{{Y}_{j}}^{{l}_{Y} \to {ϕ}_{Y}} ( t ) , {ϕ}_{Y} ∈ {Φ}_{Y} , {l}_{Y} ∈ {ℒ}_{Y} \}$$

and

$$\{ {B}_{{D}_{j}}^{{l}_{D} \to {ϕ}_{D}} ( t ) , {ϕ}_{D} ∈ {Φ}_{D} , {l}_{D} ∈ {ℒ}_{D} \}$$

between two consecutive steps t and (t−1). Besides, the generation or load curtailment statuses for any bus j∈ [symbol] ⁺ can be provided by

$${B}_{CURT , {Y}_{j}}^{{l}_{Y}} ( t ) and {B}_{CURT , {D}_{j}}^{{l}_{D}} ( t ) .$$

By solving the problem, for each time step t, we can get a set of actions for the step with long-term lookahead consideration for upcoming steps, d(t), including the total phase swapping number for each time step, loads/generations required phase swapping for each time step, and loads/generations needing curtailment for each time step.

For practical power distribution systems, this is a larger-scale mixed integer nonlinear programming (MINLP) problem. Ideally, the problem is solved as a whole, and phase-swapping decisions for all time steps are obtained simultaneously through a one-time solution. However, due to the substantial computational burden, this solution strategy may not be feasible for real-time scheduling of phase swapping. An alternative approach commonly used is solving the single-step phase swapping problem for each step within the horizon sequentially. While sacrificing some optimality significance, this method allows for obtaining a tractable solution step by step. It is hard to find a good compromise between solution optimality and computation speed using either one of these two approaches. To addresses the challenge of phase swap scheduling for larger systems, we proposed a proactive strategy to schedule phase swapping over a finite scheduling horizon. To enable this strategy, we proposed a data-driven scheduler of sequential phase-swapping based on the decisions of mixed integer nonlinear programming (MINLP) optimization. The scheduler via learned regression imitates the MINLP expert which would decide when and where the phase swapping should happen.

### Imitation Learning Based Proactive Sequential Phase Swapping Over a Finite Horizon

In this invention, the optimal multi-step phase swapping problem is cast as a Markov Decision Process (MDP). Once formulated as MDP, we argue that this sequential decision-making problem can be further simplified and implemented as the regression problem. Through this reformulation, a hybrid predictive model can be implemented to guide phase-swapping decisions. The phase swap scheduling is done by learning from the original decision of the mixed integer nonlinear programming solution and imitating the decision by a regressor. This hybrid approach uses the strengths of both traditional optimization models and regression to achieve time-efficient and robust schedule. For reducing the complexity of regression, this invention limits the decisions on the time steps required phase swapping, and the locations required phase swapping for required time steps, and detailed phase swapping actions will be determined by solving a single-step phase swapping optimization for each identified time step having a need for phase swapping and limiting phase swapping at each required time step only at determined strategical locations with consideration of time step interdependency and long-term cost savings.

Given the complex dynamics of power distribution networks, the problem of optimizing phase swapping can be formulated as an MDP. The MDP framework, allows us to systematically define the problem through states, actions, transition probabilities, and a reward function, under a discrete time horizon indexed by t∈{0,1, . . . , T}. The state of the system, S at any time t encompasses the current condition of the power distribution network. Specifically, the state includes the current load and generation on all buses and per unit cost (such as active power purchase price, reactive power purchase price, renewable generation curtailment price, and load curtailment price) profiles for the system. Actions, A are decisions made at each timestep to navigate towards optimal network performance, which include load and generation swap decisions for all buses. While transition probabilities in power systems are often governed by deterministic physical laws rather than stochastic processes, the conceptualization within an MDP framework allows for the incorporation of uncertainties and variations in network conditions, demand, and generation. To relate this objective to a reward function for any decision-making or optimization framework that might utilize rewards, such as in reinforcement learning contexts, we define the reward function R as the negative value of (9) or (38), the cost function of the optimizer. Cost function deviations are tied back to the optimization objective by negatively impacting the reward, and motivating solutions that minimize these deviations. The goal is to find a policy π: S→A that maximizes the expected cumulative reward over the horizon T, subject to the system dynamics, and operational requirements that ensures system stable and secure operation, such as load flow model to be satisfied.

Given the optimizer's role in identifying feasible phase swap schedules under fixed observations, the policy guiding these decisions inherently becomes deterministic. This results from the assumption of the predictable nature of load, generation and per-unit cost levels, which, alongside the deterministic principles governing power systems (e.g., Kirchhoff's laws), ensure that the optimizer's solution remains consistent across identical state-action pairs. Consequently, the transition between states in the network is predictable and formalized as:

$${s}^{′} = f ( s , a ) , \qquad ( 65 )$$

where s′ denotes the future state resulting from action α applied to the current state s, with ƒ(·) capturing the deterministic equations and constraints of power distribution systems.

Imitation Learning, applied within the deterministic policy context, simplifies the learning process by directly mimicking the expert policy. We consider finite-horizon MDP with horizon T. State space S is continuous while action space A is discrete and finite. Let a be the initial state distribution, and the transition function that specifies next-state distribution from state s E S under action α∈A be θ(s, α,·). Policy π(s, α) is stationary if it is mapping of states s∈S to distributions over actions α∈A. The stationary policy is deterministic if each one of its action distributions is concentrated on a single action π(s)=α, ∀s∈S. Two key assumptions from the scheduling process of phase swapping that have to be satisfied such that the problem is posed as regression are:
reward function is constrained and finite in each state 0≤R(s)≤Rₘₐₓ, ∀S∈S the apprentice policy π^{A} is deterministic policy that satisfies

$$P {r}_{( s , a ) ∼ {D}_{t}^{E}} ( {π}_{t}^{A} ( s ) \neq a ) \leq ϵ$$

where ϵ→0. The first assumption is true as in the worst-case scenario where phase swapping cannot mitigate phase imbalance the cost will be capped, and as such for other situations, can be only lower. The second assumption is true due to our previous argument on how feasible actions stem deterministic policy for each distinct load, generation and per unit cost levels.

We propose a data-driven offline approach based on imitation learning to mimic a mixed-integer nonlinear programming (MINLP) solver for problem (37), or (64) as shown in FIG. 1. The offline solving MINLP for problem (37), or (64) can generally attain global optimal solutions once all information is available, e.g., with historical data during the training phase. In order to discover the optimal policy for deciding the required time steps and locations for phase swapping according to load, generation and per unit cost profiles to the underlying optimization problem through trial and error, we let a scheduling agent, i.e. scheduler learn from the expert (i.e., an MINLP solver) directly rather than make it learn from scratch. Such kind of learning from demonstrations leads us to the field of imitation learning.

In the context of phase swapping scheduling, since the optimal decisions (including the phase swap action) can be acquired directly by solving MINLP problem assuming the availability of all information, the MINLP solver is a qualified expert and the optimal solutions of MINLP form perfect demonstrations. We then train an agent to mimic the MINLP solver to map a state to its optimal action. Given a dataset of ω state-action pairs

$$𝒟 = {\{ ( {s}_{i} , {a}_{i} ) \}}_{i = 1}^{ω}$$

extracted from expert demonstrations, a policy π that generates a desired action π(s) can be learnt to approximate the expert's optimal decision for a given state s. By doing so, the sequential decision-making problem for phase swapping is reduced to a supervised learning problem, or a regression problem in particular: we try to train a function approximator on [symbol] as the policy π.

The policy π demonstrated by the MINLP expert is approximated as π^{A} using an apprentice regressor, a deep neural network or a random forest model. The approximated policy will guide our proposed proactive phase swapping schedule strategy for determining when and where the phase swapping should take place. The agent is trained on a data set ((x₁, y₁), . . . , (x_{T}, y_{T})) where each labeled example (x₁, y₁) is drawn independently from a distribution D on X×Y. X is the feature space and Y is the finite set of labels. For the problem of phase swapping, feature space is defined over all possible generation, load and per unit cost profiles of the feeder. That means that the real and reactive powers of each bus and per-unit costs defines X. The set of labels Y represents action space, which in this case is the decision to when and where to perform load or generation phase swapping.

The Random Forest model is chosen for its robustness, scalability, and ability to handle high-dimensional data effectively. In this context, Random Forest regression is employed to determine phase swapping statuses and locations for each time step within the planning horizon. This is achieved by training multiple decision trees and outputting the mode class based on their collective predictions. During training, random samples of the training data are selected with replacement using bootstrapping. A decision tree is then built for each sample, where at each node, a random subset of features is considered for splitting. Each tree ‘votes’ for the most popular class, and the class with the highest number of votes is chosen as the predicted class. Finally, the predictions from all the trees are aggregated to produce the final prediction.

A deep neural network (DNN) is configured with multiple hidden layers between the input and output layers. These hidden layers allow DNNs to learn increasingly complex representations of the input data. In this invention, the DNN consist of an input layer, two hidden layers, and an output layer. Each layer is composed of neurons (nodes) that process and transform the input data. Relu activation functions are applied to the outputs of neurons within each layer to introduce nonlinearity into the model, enabling it to learn complex mappings between inputs and outputs. The DNN is trained using gradient-based optimization techniques such as backpropagation, where the network learns to minimize a predefined loss function by adjusting the weights and biases of the neurons through iterative optimization algorithms like stochastic gradient descent.

The power injections are used to define the input features for training samples. The power injection for each bus is defined by deducting load at the bus from generation at the bus. We divide the set of buses with non-zero power injections, [symbol] ᵢₙⱼ into two sub-sets, [symbol] _{inj-fix} and [symbol] _{inj-swap}. [symbol] _{inj-fix} is the set of buses that have power injections but non-swappable phase connections, and [symbol] _{ini-swap} is the set of buses with power injections and swappable phase connections. The features for each time step may contain total net active and reactive power injections for all fixed-connection buses for each wye-connected phase (i.e. A,B,C), and each delta-connected phase pair (i.e. AB,BC,CA), active and reactive power injections for each swappable-connection bus for each wye-connected location (i.e. A,B,C), and each delta-connected location (i.e. AB,BC,CA), and per unit purchase costs for active and reactive powers if all other per-unit costs are fixed. The label outputs for each time step may contain the total number of phase swapping, and binary values representing if phase swapping is required for each bus swappable load and generation.

Based on the results generated by the apprentice regressor, we can solve single-step phase swapping optimization problems specifically for the required time steps at designated locations. If multiple consecutive time steps require phase swapping, we can merge them into a multi-step phase swapping optimization. This guided sequential phase swapping optimization strategy can efficiently reduce the time needed to mitigate phase imbalances in power distribution systems in real time.

### Proactive Sequential Phase Swapping Algorithm for a Finite Horizon T

The detailed algorithm (Algorithm 1) for implementing proactive sequential phase swapping based on data-driven scheduler is shown in Table 1.

For real-time operation, when we get a full set of generation, load and per-unit cost forecasts for all time steps within an upcoming horizon, we can apply the trained scheduler to decide what kind of actions needed for each time step first, then take corresponding further actions when each time step is coming.

For a time step without a need for phase swapping, we can simply executive a load flow analysis to obtain required attributes for network performance, such as amount of power purchased from the substation, voltage distribution along the feeder, and current allocations within the feeder. If the system is radial, a backward/forward sweep algorithm can be used.

The backward-forward sweep algorithm iteratively calculates the complex voltage at each bus and the complex current at each branch in the distribution system. During the backward sweep, it computes the branch currents based on the specified power injections and previous computed bus voltages according to current balance equations. Then, in the forward sweep, it calculates the bus complex voltage based on voltage drop equations and the previously computed branch currents. This process continues until convergence is achieved.

For a time step with a need for phase swapping, we can executive a single-step phase swapping optimization with additional constraints to represent guided actions determined by the regressor. The additional constraints for time step t can be expressed as:

$${n}_{s w a p} ( t ) = {n}_{s w a p}^{*} ( t ) , \qquad ( 66 )$$

$${n}_{s w a p , j} ( t ) > 0 , j ∈ {𝒩}_{i n j - s w a p}^{*} ( t ) \qquad ( 67 )$$

$${n}_{s w a p}^{*} ( t ) and {𝒩}_{i n j - s w a p}^{*} ( t )$$

are the total phase swapping number, and set of buses having loads or generations having a need for phase swapping that determined by the apprentice regressor for time step t.

For a time period with consecutive steps required for phase swapping, we can formulate a multiple-step optimization using (68), or (69) to obtain detailed phase swapping decisions for each time step within the period. (68) is formulated by using load flow model with squared currents and voltages, and guided actions expressed by (66) and (67).

$$\begin{matrix}( 1 ) & \\ Minimize {\sum }_{t = {T}_{b}}^{{T}_{e}} {J}^{S Q} ( t ) & ( 68 a )\end{matrix}$$

$$Subject to :$$

$$Constraints ( 10 ) \sim ( 36 ) , t = {T}_{b} , … , {T}_{e} \qquad ( 68 b )$$

$$Constraints ( 66 ) \sim ( 67 ) , t = {T}_{b} , … , {T}_{e} \qquad ( 68 C )$$

T_{b} and Tₑ are the beginning time step and the ending time step, respectively. For a single time step, the beginning and ending time steps are set as the same.

(69) is formulated by using load flow model with explicit currents and voltages, and guided actions expressed by (66) and (67):

$$\begin{matrix}( 1 ) & \\ Minimize {\sum }_{t = {T}_{b}}^{{T}_{e}} {J}^{EXP} ( t ) & ( 69 a )\end{matrix}$$

$$Subject to :$$

$$Constraints ( 38 ) \sim ( 63 ) , t = {T}_{b} , … , {T}_{e} \qquad ( 69 b )$$

$$Constraints ( 66 ) \sim ( 67 ) , t = {T}_{b} , … , {T}_{e} \qquad ( 69 C )$$

TABLE 1
Algorithm 1 Proactive Sequential Phase
Swapping with Data-Driven Scheduler

L ← obtain generation, load and per unit profiles for upcoming horizon
T
t ← 1
while t ≤ T do
gₜ ← π^{A}(L(t)), obtain guided phase swapping actions
if gₜ does not include phase swapping then
calculate load flow using backward/forward sweep algorithm
else if gₜ includes phase swapping then
determine phase swapping using single-step optimization with
constraints of guided actions
end if
t ← t + 1
end while

### Numerical Examples

To demonstrate the effectiveness of the invented approach, we tested various phase swapping strategies on the modified IEEE 13-node feeder. The scheduling horizon includes 24 time steps, each lasting one hour.

As shown in FIG. 2C, the test feeder has three non-swappable (i.e., connection-fixed) loads, including delta-connected loads at bus 671 and wye-connected loads at buses 634 and 675. It also has seven swappable generations and loads. The swappable generations are located at buses 680 and 684, and these two delta-connected generations are initially connected with phases CA and AB, respectively. The generation at bus 680 is a wind power plant, and the generation at bus 684 is a solar power plant. The single-phase loads connected to bus 611, bus 645, and bus 652 are wye-connected with initial locations at phase C, phase B, and phase A, respectively. The single-phase loads connected to buses 646 and 692 are delta-connected, with initial locations between phases BC and CA, respectively.

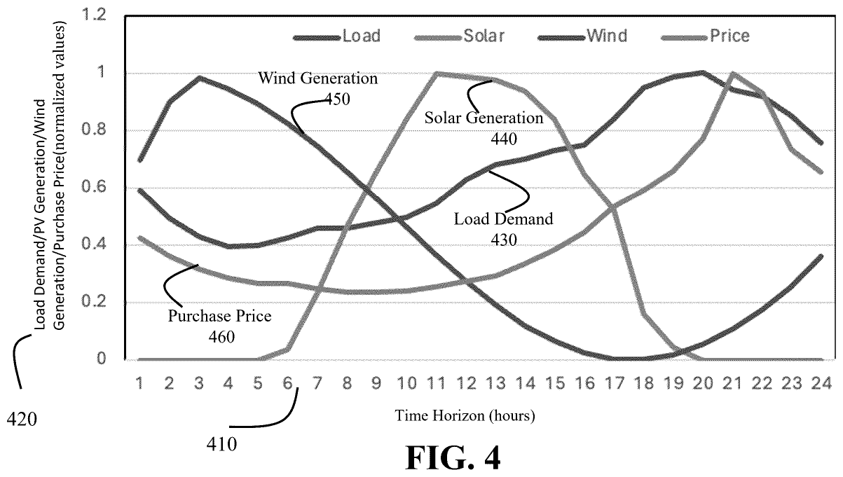

FIG. 4 shows the normalized profiles for load demands, solar generation, wind generation, and active power purchase prices for the test system. The horizontal axis 410 represents the time steps along the scheduling horizon, and the vertical axis 420 represents the corresponding normalized values of the load profile 430, PV generation profile 440, wind generation profile 450, and active power purchase price profile 460.

Four phase swapping scenarios are implemented and compared:
Scenario I: No phase swapping.
Scenario II: Sequential single-step phase swapping optimization.
Scenario III: Simultaneous multi-step phase swapping optimization.
Scenario IV: Proactive sequential phase swapping optimization.

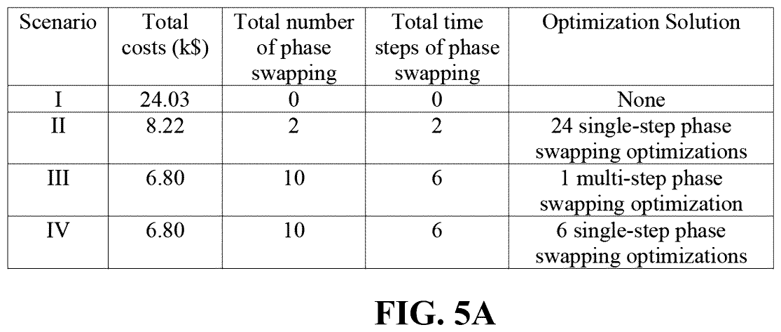

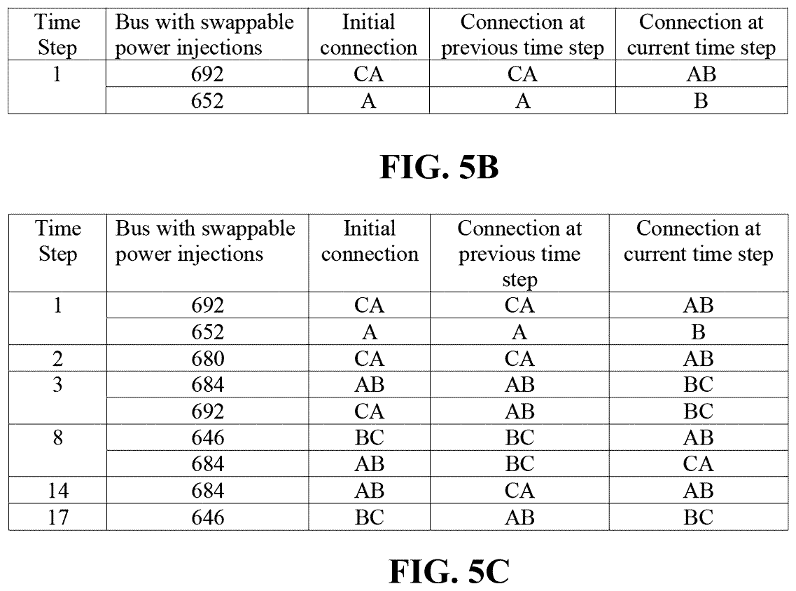

FIG. 5A compares test results for various phase swapping scenarios. As shown in the figure, the total cost is highest for the scenario without phase swapping (Scenario I). While more phase swapping actions are required, the cost for the multi-step phase swapping scenario or proactive sequential phase swapping (Scenario III or IV) is lower than that for the sequential single-step phase swapping strategy (Scenario II). The proactive sequential phase swapping strategy (Scenario IV) requires the same number of phase swaps and incurs the same cost but demands less computational effort compared to the simultaneous multi-step phase swapping scenario (Scenario III). This comparison underscores the necessity of phase swapping and the effectiveness of the proposed approach in scheduling phase swapping schemes over a finite horizon.

FIG. 5B lists the phase swapping schedule determined using a sequential single-step phase swapping optimization strategy, i.e. Scenario II.

FIG. 5C lists the phase swapping schedule determined using a simultaneous multi-step phase swapping optimization strategy (i.e. Scenario III), or a proactive sequential phase swapping optimization strategy (i.e. Scenario IV). Scenario IV and scenario III have the same phase connection changes, so there are no differences on network performances for those two strategies.

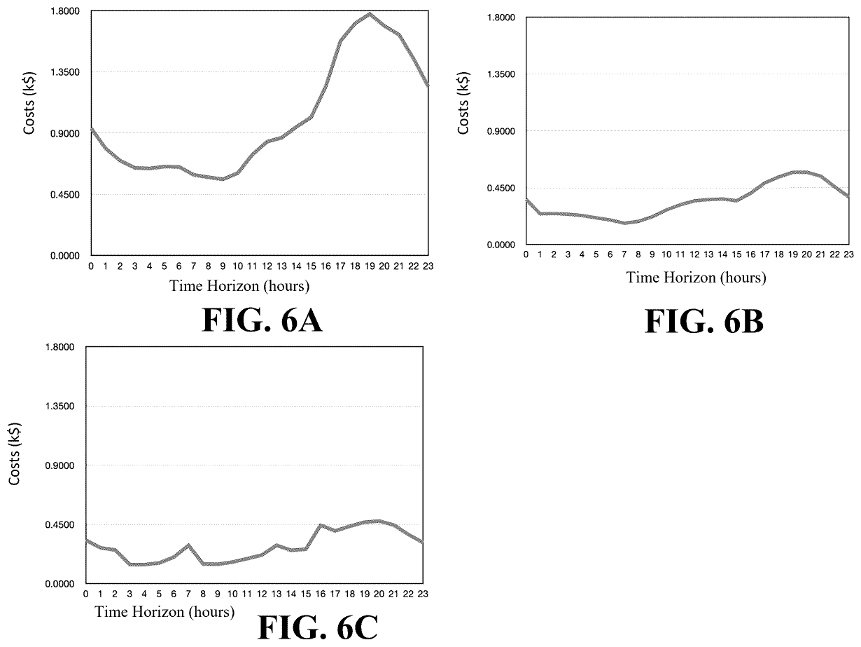

FIGS. 6A-6C compare cost variations along the scheduling horizon for different phase swapping scenarios.

FIG. 6A depicts total operational cost variations over time within the finite scheduling horizon using no phase swapping strategy (i.e. Scenario-I).

FIG. 6B depicts total operational cost variations over time within the finite scheduling horizon using the sequential single-step phase swapping strategy (i.e. Scenario-II).

FIG. 6C depicts total operational cost variations over time within the finite scheduling horizon using the simultaneous multi-step phase swapping strategy or proactive sequential phase swapping strategy (i.e. Scenario-III or IV).

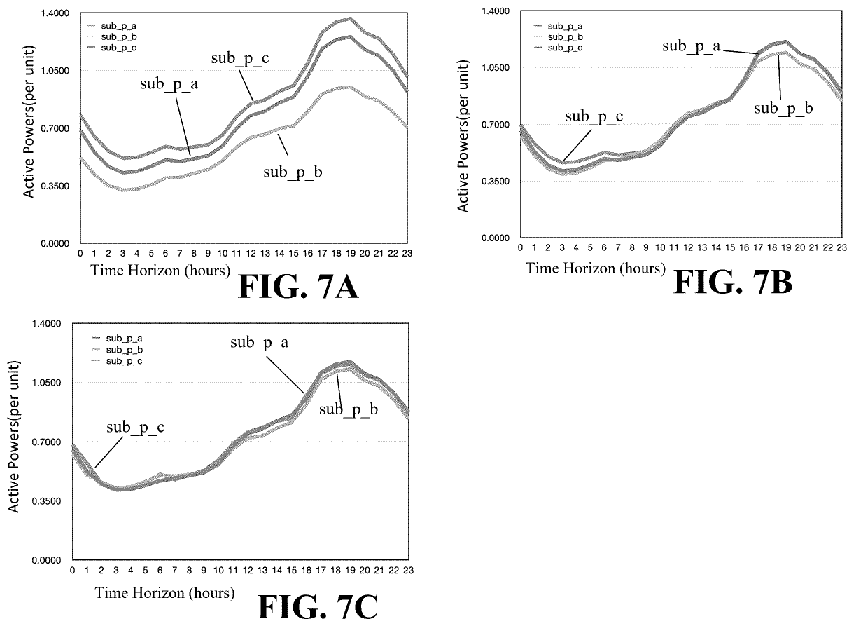

FIGS. 7A-7C compare active power variations of the substation along the scheduling horizon for different phase swapping scenarios. The labels “sub_p_a,” “sub_p_b,” and “sub_p_c” represent the active powers on phases a, b, and c of the substation, respectively.

FIG. 7A depicts substation by-phase active power variations over time within the finite scheduling horizon using the no phase swapping strategy (i.e., Scenario I).

FIG. 7B depicts substation by-phase active power variations over time within the finite scheduling horizon using the sequential single-step phase swapping strategy (i.e., Scenario II).

FIG. 7C depicts substation by-phase active power variations over time within the finite scheduling horizon using the simultaneous multi-step phase swapping strategy or the proactive sequential phase swapping strategy (i.e., Scenario III or IV).

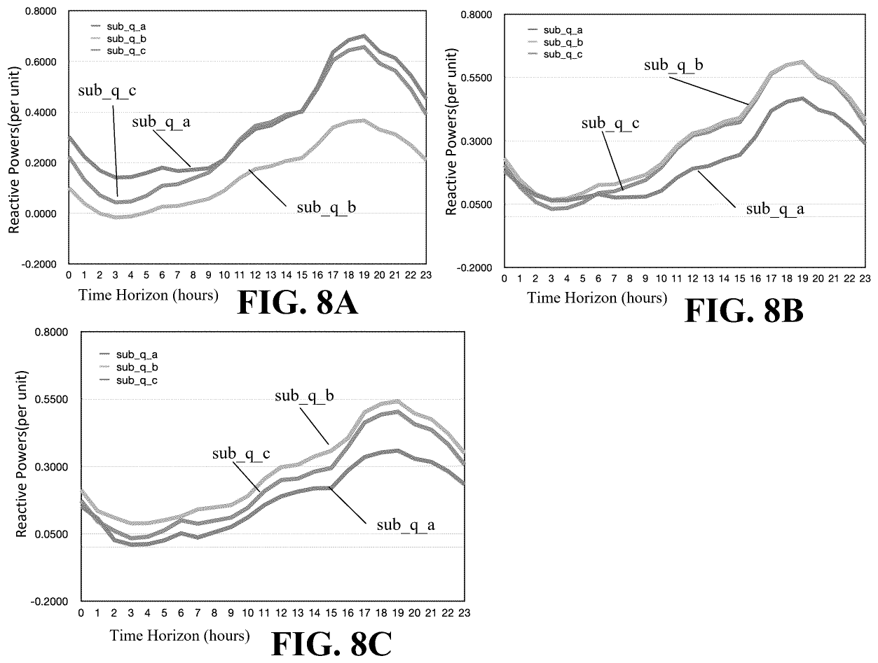

FIGS. 8A-8C compare reactive power variations of the substation along the scheduling horizon for different phase swapping scenarios. The labels “sub_q_a,” “sub_q_b,” and “sub_q_c” represent the reactive powers on phases a, b, and c of the substation, respectively.

FIG. 8A depicts substation by-phase reactive power variations over time within the finite scheduling horizon using no phase swapping strategy(i.e. Scenario-I).

FIG. 8B depicts substation by-phase reactive power variations over time within the finite scheduling horizon using the sequential single-step phase swapping strategy (i.e. Scenario-II).

FIG. 8C depicts substation by-phase reactive power variations over time within the finite scheduling horizon using the simultaneous multi-step phase swapping strategy or guided sequential single-step phase swapping strategy (i.e. Scenario-III or IV).

Upon examining these figures, it becomes evident that the proposed proactive sequential phase swapping strategy, which utilizes guided sequential single-step phase swapping optimizations, offers not only reduced operational costs but also improved power quality compared to strategies involving no-phase swapping or sequential single-step phase swapping. Moreover, it demands less computational effort than simultaneous multi-step phase swapping optimization.

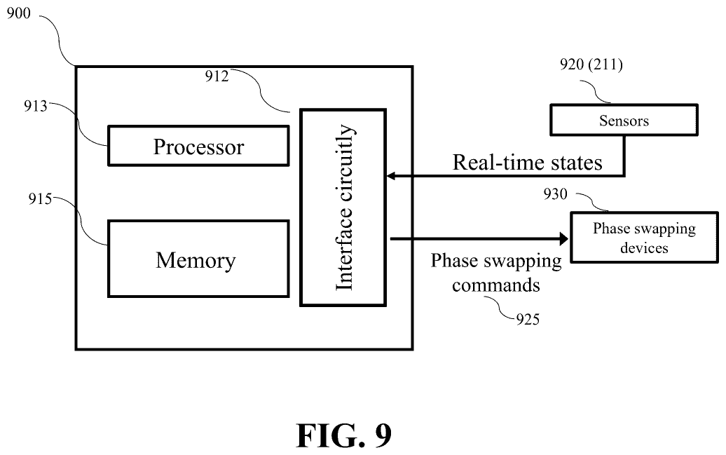

FIG. 9 shows a schematic of a system for proactive sequential phase swapping in power distribution systems over a finite scheduling horizon.

The phase swapping system 900 facilitates phase swapping within a power distribution system 200. It includes interface circuitry 912 designed to receive real-time states at time t from sensors 920 (211 in FIG. 2B) located at buses in the power distribution system. Each real-time state corresponds to the complex power flowing from an upstream bus to a downstream bus, and may include per-unit cost for the distribution system. The system also incorporates one or more processors 913 and a non-transitory computer-readable storage medium 915, referred to interchangeably as memory or storage.

When the computer-executable instructions stored in the medium 915 are executed by the processors 913, the system performs steps to determine a multi-step phase swapping action using the real-time states and a trained optimal policy. This policy generates phase swapping commands based on the determined action. Subsequently, the processors 913 transmit these phase swapping commands 925 to phase swapping devices 930 located near the sensors 920 via the interface circuitry 912. The phase swapping devices 930 then execute the multi-step phase swapping action based on the received commands 925.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component. Though, a processor may be implemented using circuitry in any suitable format.

Also, the embodiments of the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Although the invention has been described by way of examples of preferred embodiments, it is to be understood that various other adaptations and modifications can be made within the spirit and scope of the invention.

Therefore, it is the object of the appended claims to cover all such variations and modifications as come within the true spirit and scope of the invention.

1. A phase swapping system for swapping phases in a power distribution system, comprising:
an interface circuitry configured to receive, from sensors arranged at buses in the power distribution system, real-time states at current time step of a scheduling horizon, wherein each of the real-time states are associated with a complex power flowing from an upstream bus to a downstream bus; and
one or more processors and a non-transitory computer-readable storage medium having stored thereon executable instructions that, when executed by the one or more processors, cause the phase swapping system to perform steps of:
determining a multi-step phase swapping action by using the real-time states and a trained optimal policy;
generating phase swapping commands based on the multi-step phase swapping action; and
transmitting, via the interface circuitry, the phase swapping commands to phase swapping devices arranged at around the sensors, wherein the phase swapping devices are configured to perform the multi-step phase swapping action based on the phase swapping commands.

2. The phase swapping system of claim 1, wherein the optimal policy is pretrained offline for the scheduling horizon by using a state-action training set, wherein the state-action training set is generated for determining the multi-step phase swapping action for a training scenario using a multi-step mixed-integer non-linear programming (MINLP), wherein the training scenario is represented by using generation, load profiles for all buses and per-unit cost profiles with respect to the power distribution system.

3. The phase swapping system of claim 1, wherein the trained optimal policy is used to determine a guided set for phase swapping action corresponding to the generation, load and per-unit cost profiles for the scheduling horizon, wherein the guided set for phase swapping action defining time steps, total number of switching, and corresponding locations required for phase swapping.

4. The phase swapping system of claim 1, wherein the multi-step phase swapping action is generated by sequentially determining phase swapping action for each single time step that required phase swapping determined by the optimal policy; wherein single-step phase swapping action is obtained by solving a single-step phase swapping optimization model that formulated by minimizing weighted sum of multiple operational cost functions subject to constraints of radial load flow, substation voltage settings, phase swapping feasibility and a guided set of phase swapping action for the time step.

5. The phase swapping system of claim 4, wherein a multi-step phase swapping optimization model is used for generating single-step phase swapping action for each of multiple consecutive time steps that required phase swapping determined by the optimal policy.

6. The phase swapping system of claim 1, wherein the trained optimal policy is approximated with a deep neural network or random forest model, wherein inputs of the deep neural network or random forest model comprise profiles of power injections resulting from generations and loads with respect to wye-connected and delta-connected phases and locations, and profiles of per unit cost of the distribution system; wherein outputs of the deep neural network or random forest model include total number of phase swapping for each time step, and statuses for phase swapping for each wye-connected and delta-connected loads and generations.

7. The phase swapping system of claim 6, wherein the inputs for each time step include at least total net active and reactive power injections for all fixed-connection buses for each wye-connected phase, and each delta-connected phase pair, active and reactive power injections for each swappable-connection bus for each wye-connected location, and each delta-connected location, and per unit purchase costs for active and reactive powers.

8. The phase swapping system of claim 2, wherein the multi-step phase swapping action is determined by minimizing a cost function, wherein the cost function is expressed as a weighted sum of multiple cost components including a production cost for substation power purchase and generation and load curtailments, a penalty cost for branch current limit and bus voltage limit violations, a penalty cost for active power, reactive power, current and voltage imbalances, and a cost for phase swapping operations for all time steps within a scheduling horizon, while satisfied at least constraints of radial load flow for all time steps within the horizon.

9. The phase swapping system of claim 1, wherein each generation and load is wye-connected or delta-connected, wherein each wye-connected generation and load have three wye-connected locations and each location may assign to a wye-connected phase, wherein each delta-connected generation and load have three delta-connected locations and each location may assign to a delta-connected phase-pair.

10. The phase swapping system of claim 9, wherein delta-connected generation and load is converted to equivalent wye-connected generation and load through a delta-to-wye coversion matrix defined by assuming balanced three phases.

11. The phase swapping system of claim 8, wherein radial load flow model is used to represent operational constraints of the power distribution system by using a generic branch model; wherein the generic branch is a line segment, a voltage regulator, or a transformer; wherein the load flow for each branch is represented using a set of equations related to branch voltage drop, bus current balance or bus power balance, and power flows relating to bus voltages and branch currents or branch powers.

12. The phase swapping system of claim 11, wherein the generic branch is represented using a regulated π model; where the regulated π model connects a regulation component with a series branch, wherein the regulation component is modeled using a voltage amplifying matrix and a current amplifying matrix, and the series branch is modeled using a series impedance matrix and two shunt admittance matrices at its terminal buses.

13. The phase swapping system of claim 11, wherein squared branch currents and squared branch currents are used to represent branch voltage drop, bus power balance and relating expanded power flows with squared currents and squared voltages based on the regulated π model; wherein a squared current is defined as a vector of phase currents times a conjugate transpose of the vector of phase current, wherein a squared voltage is defined as a vector of phase voltage times a conjugate transpose of the vector of phase voltages; wherein a expanded power flow is defined as a vector of bus phase voltages times a vector of branch phase currents.

14. The phase swapping system of claim 11, wherein branch currents and bus voltages are used to represent branch voltage drop, bus current balance and relating power flows with branch currents and bus voltages based on the regulated π model.

15. The phase swapping system of claim 1, wherein phase swapping action is represented by using a matrix for assigning each wye-connected location to a phase for each wye-connected load and generation, and a matrix for assigning each delta-connected location to a phase-pair for each delta-connected generation and load.

16. The phase swapping system of claim 1, wherein phase swapping command for a wye-connected generation or load is described by a series of connected phases at previous and current time steps, wherein phase swapping command for a delta-connected generation or load is described by a series of phase-pairs at previous and current time steps.

17. A non-transitory computer-readable medium storing a phase swapping program including instructions that, when executed by a processor, causes a phase swapping system connected to a power distribution system through an interface circuitry, to:
receive, from sensors arranged at buses in the power distribution system, real-time states at current time step of a scheduling horizon, wherein each of the real-time states are associated with a complex power flowing from an upstream bus to a downstream bus;
determine a multi-step phase swapping action by using the real-time states and a trained optimal policy;
generate phase swapping commands based on the multi-step phase swapping action; and
transmit, via the interface circuitry, the phase swapping commands to phase swapping devices arranged at around the sensors, wherein the phase swapping devices are configured to perform the multi-step phase swapping action based on the phase swapping commands.

18. The non-transitory computer-readable medium of claim 17, wherein the optimal policy is pretrained offline for the scheduling horizon by using a state-action training set, wherein the state-action training set is generated for determining the multi-step phase swapping action for a training scenario using a multi-step mixed-integer non-linear programming (MINLP), wherein the training scenario is represented by using generation, load profiles for all buses and per-unit cost profiles with respect to the power distribution system.

19. The non-transitory computer-readable medium of claim 17, wherein the trained optimal policy is used to determine a guided set for phase swapping action corresponding to the generation, load and per-unit cost profiles for the scheduling horizon, wherein the guided set for phase swapping action defining time steps, total number of switching, and corresponding locations required for phase swapping.

20. The non-transitory computer-readable medium of claim 17, wherein the multi-step phase swapping action is generated by sequentially determining phase swapping action for each single time step that required phase swapping determined by the optimal policy; wherein single-step phase swapping action is obtained by solving a single-step phase swapping optimization model that formulated by minimizing weighted sum of multiple operational cost functions subject to constraints of radial load flow, substation voltage settings, phase swapping feasibility and a guided set of phase swapping action for the time step.
